(19) United States
(12) Patent Application Publication
(10) Pub. No.: US 2008/0095209 A1
(43) Pub. Date: Apr. 24, 2008

(54) Laser device for exposure device

(75) Inventors: Osamu Wakabayashi, Hiratsuka-shi (JP); Tsukasa Hori, Hiratsuka-shi (JP); Takanobu Ishihara, Hiratsuka-shi (JP); Shinji Nagai, Hiratsuka-shi (JP); Hakaru Mizoguchi, Oyama-shi (JP); Kouji Kakizaki, Oyama-shi (JP)

Correspondence Address: Gerald T. Shekleton;Welsh & Katz, Ltd., 22nd Floor, 120 South Riverside Plaza, Chicago, IL, 60606-3945, US

(73) Assignees: KOMATSU LTD.,; USHIO DENKI.

(21) Appl. No.: 11/903,111

(22) Filed: Sep. 19, 2007

(30) Foreign Application Priority Data
Sep. 21, 2006 (JP) 2006-255619

(51) Int. Cl. H01S 3/22

(52) U.S. Cl. 372/57

(57) ABSTRACT

A high efficiency injection device 4, which injects oscillation stage laser light into an optical stable resonator of an amplification stage laser 20, is provided. A discharge electrode 1a is disposed in an oscillation stage laser 10, and is connected to a 12 kHz power supply 15 for discharging the discharge electrode 1a, and also a plurality of pairs of discharge electrodes 2a, 2b are disposed within the optical stable resonator of the amplification stage laser 20, and are connected to 6 kHz power supplies 25a, 25b for discharging the respective electrode pairs 2a, 2b. Discharge voltages are applied alternately to the two pairs of electrodes 2a, 2b in synchronization with the injected light to cause discharge.

### BACKGROUND OF THE INVENTION

1. Field of the Invention

The present invention relates to an injection locked laser device for an exposure device that includes a line narrowed oscillation stage laser and an amplification stage laser containing at least one set of optical stable resonators, and more particularly relates to a laser device for an exposure device capable of high output at high repetition frequency.

2. Description of the Related Art

In recent years, there has been a demand for laser devices having simultaneously high repetition rate, high output, and ultra line narrowed spectrum for exposure, in order to improve the throughput of exposure machines and to achieve uniform ultra-micro processing.

In order to simultaneously achieve the requirements of ultra line narrowed spectrum and high output, injection locked laser devices using two stage lasers have been proposed.

The first oscillation stage laser has low pulse energy and an ultra line narrowed spectrum. The second amplification stage laser amplifies only the pulse energy, while maintaining the ultra line narrowed spectrum of the oscillation stage laser. The required ultra line narrowed spectrum and high output can be obtained using this two stage laser device.

The configurations of these two stage laser devices can be broadly classified into the Master Oscillator Power Amplifier (MOPA) configuration, in which resonator mirrors are not provided on the amplifier stage, and the Master Oscillator Power Oscillator (MOPO) configuration in which resonator mirrors are provided.

FIGS. 20(a) and 20(b) show examples of the outline configuration of two stage laser devices. FIG. 20(a) shows a MOPA type, and FIG. 20(b) shows a MOPO type.

In FIGS. 20(a) and 20(b), the laser beam emitted from an oscillation stage laser (MO) 100 functions as a seed laser beam, and an amplifier (PA) 200 or an amplification stage laser (PO) 210 has the function of amplifying the seed laser light. In other words, the overall spectral characteristics of the laser device are determined by the spectral characteristics of the oscillation stage laser 100, and the laser output (energy or power) of the laser device is determined by the amplifier 200 or the amplification stage laser 210.

In the MOPA laser device of FIG. 20(a), the oscillation stage laser (MO) 100 and the amplifier (PA) 200 have their respective laser chambers 101, 201, the interiors of which are filled with laser gas, and a pair of electrodes (not shown in the drawings) is disposed in opposition and separated by a predetermined distance within the laser chambers 101, 201, and electrical discharge is generated by applying a high voltage pulse to these pairs of electrodes.

Also, a window (not shown in the drawings) made from a material that has transmittivity with respect to the laser oscillation light is disposed in each of the chambers of the oscillation stage laser 100 and the amplification stage laser 200. Also, cross flow fans which are not shown in the drawings are disposed within the chambers 101, 201, which circulate the laser gas within the chambers 101, 201, and drive the laser gas into the discharge unit referred to above.

The oscillation stage laser 100 includes a line narrowing module (LNM) 300 constituted by a magnifying prism 301 and a grating (diffraction grating) 302, and a laser resonator is constituted by optical elements and a front mirror 102 within the line narrowing module 300.

The laser beam (seed laser beam) from the oscillation stage laser 100 is led via a beam transmission system 400 that includes a reflection mirror and so on into the amplifier (PA) 200, where the laser beam is amplified and output as the output laser beam.

In the MOPA configuration shown in FIG. 20(a), a resonator mirror is not provided in the amplifier (PA) 200, but in the MOPO configuration shown in FIG. 20(b), one set of optical stable resonators that includes for example a rear mirror 211 and a front mirror 212 is disposed in the amplification stage laser 210, so that even small inputs can be amplified. Also, the injected seed laser beam is reflected between the front mirror 212 and the rear mirror 211 as indicated by the arrow in this drawing, the laser beam power is amplified when effectively passing the discharge unit, and the laser light is output from the front mirror 212.

However, with the progress of the technology node from the 45 nm to the 32 nm node, attention is focusing on high NA (1.3 to 1.5) and double exposure using liquid immersion technology for exposure devices using ArF lasers as the light source.

The requirements for the light source of ArF laser exposure devices are as follows.

1. High repetition frequency (10 kHz or greater) and high average output (100 W or greater) together with maintenance of high dose stability and high throughput are required.

2. High NA together with ultra narrow line narrowed spectrum (0.1 pm or less) are required.

3. In order to reduce the effect of the spectrum on the mask in the exposure device, low spatial coherence of the output laser light is required.

In recent laser devices for exposure, in addition to ultra line narrowed spectrum and high output as discussed above, a high repetition rate is required. To meet the requirement of high repetition rate, two pairs of discharge electrodes may be disposed in the amplification stage laser, as in the laser device disclosed in U.S. Pat. No. 7,006,547 (hereafter referred to as Document 1) for example, and by alternately discharging the pairs of discharge electrodes, it is possible to meet the requirement for high repetition rate to a certain extent.

FIGS. 21(a) and 21(b) show the outline constitution of the laser device disclosed in Document 1. FIG. 20(a) shows a side view, and FIG. 20(b) shows a top view of the amplifier (PA).

The laser device shown in FIGS. 21(a) and 21(b) is a MOPA configuration laser device, that includes a single high repetition rate oscillation stage laser (MO), and at least two amplifiers (PA) (a plurality of sets of electrodes may be disposed within the same chamber), the repetition frequency of a single oscillating stage laser (MO) is for example 4 kHz or higher, and the repetition frequency of the amplifier (PA) is for example 2 kHz or higher, and their operation is synchronized.

In FIGS. 21(a) and 21(b), the repetition frequency of the oscillation stage laser 100 is for example 4 kHz or higher, and the laser beam 140A from the oscillating stage laser 100 is led via reflection mirrors 240A, 240B and so on into the amplifier (PA) 200.

Two pairs of discharge electrodes 90A-92A, 90B-92B are disposed within the amplifier (PA) 200, alternately discharging at for example 2 kHz or greater, the injected laser beam is reflected by reflection mirrors 240B, 240C1, 240C2, as shown in FIG. 21(b), amplified, and the laser light is output.

Among normal free running laser devices, laser devices in which a plurality of groups of pairs of electrodes within the laser chamber are disposed in series and operated alternately to achieve high repetition rate operation, as disclosed in Japanese Patent Application Laid-open No. S63-98172 (hereafter referred to as Document 2) for example, are conventionally known.

To achieve an ultra line narrowed laser device with a laser repetition frequency 10 kHz or higher, and a laser output of 100 W or higher using the MOPA configuration laser device of Document 1, the following problems arise.

1. In the case of the MOPA configuration, the pulse energy required of the oscillating stage laser (MO) is 1 mJ, but it was difficult to achieve high repetition frequencies (10 kHz or higher), pulse energy 1 mJ or higher, and also ultra line narrowed spectrum (0.1 pm or less) in the oscillation stage laser (MO).

FIG. 22 shows the relationship between the injected pulse energy (mJ) and the pulse energy (mJ) after amplification in the MOPA and MOPO configuration laser devices, the amplification efficiency of the MOPA system is worse than the MOPO system, and if the required laser output after amplification is 16 mJ, a pulse energy of 1 mJ is required for the injection with the MOPA configuration. In contrast to this, 0.1 mJ is sufficient with the MOPO configuration.

2. The laser pulse energy of the amplifier (PA) after amplification is low, so electrode length of a certain length is necessary, for example, in the case of operation of the series divided electrodes shown in FIGS. 21(a) and 21(b), the length of the laser chamber is about twice the length of a conventional chamber, so the size in increased.

As stated above, in the MOPA configuration, it is necessary to increase the injection pulse energy. On the other hand, in the case of the MOPO configuration, the pulse energy required of the oscillating stage laser (MO) is comparatively low.

However, to achieve a high repetition rate, high output, and ultra line narrowed laser device with the MOPO system, the following problem must be solved.

In other words, for a high repetition rate (10 kHz or higher), and high pulse energy (15 mJ or higher), the energy load on the resonator of the amplification stage laser (PO) increases, so damage to the resonator increases. In order to reduce the energy load on the resonator of the amplification stage laser (PO), and achieve high pulse energy, a large discharge cross-sectional area is necessary.

FIG. 23 shows a section through the laser chamber of a discharge excitation laser device.

A laser chamber 100 includes a cross flow fan 121 to drive the laser gas between the electrodes; a heat exchanger 122 to cool the laser gas after discharge; an anode electrode 131 and a cathode electrode 132 to excite discharge; and an air flow guide 123 to efficiently guide the flow of laser gas generated by the cross flow fan 121 between the electrodes. Also, insulating ceramics 124 are provided between a power supply 133 and the electrode 132, and further, a pre-ionization electrode 125 is provided near the electrode 131.

When a voltage is applied to the pre-ionization electrodes 125 from the power supply 133, first the discharge space is pre-ionized, then a pulse voltage is applied to the electrodes 131, 132, and an electrical current flows between the cathode electrode 132 and the anode electrode 131 to cause discharge.

Here, in order to double the repetition frequency, it is necessary to double the gas flow rate due to the cross flow fan 121, but to double the flow rate the power of the fan within the chamber must be increased by a factor of 2³=8. Therefore it was difficult to substantially increase the repetition rate by increasing the gas flow rate.

Therefore as explained above, with the MOPO configuration, although the pulse energy required of the oscillation stage laser (MO) is comparatively small, to achieve a high repetition rate, high output, and ultra line narrowed laser device with the MOPO configuration, there are many problems that have to be solved, such as the method of injection of the light output from the oscillation stage laser to the amplification stage laser (MO), the arrangement and constitution of the electrodes, and so on.

These are referred to in Document 1 regarding the application of the MOPO configuration, but a specific measure has not been developed to achieve high repetition rate, high output, and ultra line narrowed spectrum.

### SUMMARY OF THE INVENTION

With the foregoing in view, it is an object of the present invention to provide a laser device for an exposure device capable of achieving high repetition rate (10 kHz or higher), high output, and ultra line narrowed spectrum (0.1 pm or less).

In excimer lasers, the most effective measure for increasing the repetition rate is to narrow the discharge width. Generally, in excimer lasers the maximum repetition frequency at which operation is possible is explained by reference to the clearance ratio (CR). As shown in FIG. 24, for a gas flow rate v between electrodes 131, 132, discharge width W, and time interval between discharge t, and electrode gap G the CR is the product of the gas flow rate v and the tine interval between discharge t, divided by the discharge width W, or CR=vt/W.

When CR is sufficiently large, discharge is stable, and repetitive operation is possible. If the CR is large, discharge occurs stably, and the energy stability of the laser is also good.

The following is an explanation of the CR from the point of view of physical phenomena.

Ions, activated species, and other products generated by discharge, and dust and debris from the electrodes significantly reduce the discharge resistance of the gas. Also, as a result of discharge, a rarified gas region is formed, and the gas pressure in this region is relatively low, so the discharge resistance is small. Therefore if this region (products generated by discharge) is close to the electrodes, the next discharge that occurs will not be between the electrodes, but will occur in this region (the abnormal discharge shown in FIG. 24 occurs).

If the CR is large, it means that when the next discharge occurs, these products generated by discharge will be far from the vicinity of the electrodes.

The necessary value of the CR varies depending on the use of the laser. For applications in which energy stability of the laser is not required so much, the CR may be about 1. However, when used as the light source for semiconductor exposure, high energy stability is required, so a CR in the range 2 to 3 is required. Therefore, if for example the discharge width is 3 mm and operation is at 6 kHz, a gas flow rate between the electrodes of 50 meters per second is necessary.

In order to increase the laser repetition frequency, from the point of view of the CR, two measures can be considered. For example, to increase the repetition frequency of a laser from 6 kHz to 12 kHz, while maintaining the energy stability of the laser, assuming the CR is constant in the range 2 to 3, then either the gas flow rate v must be doubled, or the electrode width W must be reduced to half.

For a practical laser device, of the two measures, the former is especially difficult. This is because to double the gas flow rate, it is necessary to increase the electrical power of the motor driving the cross flow fan by a factor of eight.

On the other hand, the method of narrowing the discharge width is the method of narrowing the electrode width in the discharge unit. However, as a result of various investigations, it was found that just narrowing the electrode width does not necessarily narrow the discharge width, but by narrowing the distance between the electrodes (electrode gap) the discharge width is narrowed. In other words, if the distance between electrodes is shortened, the electrical lines of force between the electrodes do not widen but remain approximately parallel in all locations, so the forces that restrict the discharge are strong. Therefore, it can be inferred that the discharge width does not widen, but the discharge width becomes narrow in accordance with the design.

FIG. 25 shows the results of measurements of the relationship between the relative values of electrode gap and the discharge width, for electrodes to which the input energy density is constant, and the discharge electrode widths are constant (cathode electrode width: 1.5 mm, anode electrode width: 2 mm). It can be seen that by reducing the gap from 16 mm to 10 mm while keeping the electrode width the same, the discharge width is reduced to about 70% compared with that of the 16 mm gap.

The discharge width can be specifically measured as follows.

FIGS. 26(a) and 26(b) show an example of the constitution of the system for measuring the discharge width W by the Mach-Zhender interferometer.

A light beam from a coherent pulse laser 401 enters a beam expander 403 via a mirror 402, and the beam is expanded equal to or greater than the discharge area of the laser 400 by the beam expander 403.

The beam is divided equally in two by a half mirror 404 into a beam that passes through the laser chamber 405 and a beam that does not, one beam enters the laser chamber 405, and the other enters a half mirror 408 via a high reflection mirror 410.

Discharge electrodes 406 are provided within the laser chamber 405, and by applying a discharge voltage to the discharge electrodes 406 to cause discharge, the light incident on the laser chamber 405 passes through the discharge area between the discharge electrodes 406 and is output.

The output light of the laser 400 is reflected by a high reflection mirror 407 and enters the half mirror 408, is merged with the light incident on the half mirror 408 via the high reflection mirror 410, and the merged light enters a CCD camera 411 via an interference filter 409.

Interference occurs between these two beams, the beam that passes through the laser chamber 405 and the beam that does not, to generate interference fringes. In other words. Assuming the wavelength of the pulse laser to be λ, if the difference in the light path Δ is an odd-numbered multiple of half a wavelength λ/2, the peaks and troughs of the two light beams combine and cancel each other to form a dark fringe, and if the difference in the light path is an even-numbered multiple the peaks and troughs strengthen each other to form a bright fringe. If the light path difference Δ is the same on the entire image plane, then the image will have a uniform brightness.

Here, as shown in FIG. 26(b), when discharge occurs between the cathode electrode 406a and the anode electrode 406b, the electron density increases, and the diffraction ratio of the discharge area changes. Therefore, the interferometer can measure the discharge width W as the width of the area in which the interference fringes are distorted.

Also, as a simple method for measuring the discharge width, as shown in FIG. 27, the beam width may be measured instead by disposing an OC 412 (output coupler) to the front of the laser chamber 405 and a rear mirror 413 to the rear, and detecting and measuring the beam profile of the laser oscillations at the position of the OC 412 with a CCD 416.

A transfer lens 415 forms an image of the beam at the position of the OC 412 in the CCD 416. The definition of the discharge width may be taken to be for example the peak strength multiplied by 1/e or 1/e².

According to the concept of the CR, to enable a high repetition rate, the discharge resistance may be reduced in some cases.

As stated above, if there are products generated by the discharge in the vicinity of the discharge, discharge between the electrodes might not occur, but abnormal discharge may occur, which is detrimental to the energy stability of the laser. At this time, whether discharge occurs between the electrodes in accordance with the design, or abnormal discharge occurs in the area where the products generated by discharge are, depends on the difference in discharge resistance between the two.

Therefore, in the case where the discharge resistance in the area between the electrodes is smaller than that in the area where the products generated by discharge exist, even if the CR is small, in other words, even if the products generated by discharge are near the electrodes, stable discharge can occur. Reducing the distance between the electrodes and increasing the strength of the electric field between the electrodes just reduces the discharge resistance, and this is an effective method of stabilizing the output of the laser when the repetition rate is high.

From the results of tests, for a design discharge width of 3 mm, a distance between the electrodes of 16 mm is effective, and for a design discharge width of 1 mm, a distance between electrodes of 8 mm is effective. Therefore, the effective aspect ratio of the discharge width and distance between electrodes (ratio of discharge width to distance between electrodes) for high repetition rate operation is between 1:8 and 3:16, in other words, 0.125 to 1.875.

From the above test results, in order to narrow the discharge width of a oscillation stage laser (MO) with a repetition frequency of 12 kHz, it is necessary to narrow the electrode width to 1 mm, and shorten the electrode gap to 8 mm.

Furthermore, assuming the gas flow rate can be maintained the same, if the electrode gap is shortened, the gas flow velocity through the electrode gap speeds up in inverse proportion to the electrode gap G. Therefore, by narrowing the electrode gap, the effect of increasing the gas velocity can be obtained, which could allow the repetition rate to be further increased.

As described above, in order to achieve a high repetition rate oscillation stage laser (MO), it is necessary to narrow the electrode width and shorten the electrode gap. In this case, the cross-sectional area of discharge is reduced, so the output from the oscillation stage laser (MO) becomes small.

Therefore, in the case that a MOPA configuration as disclosed in Patent Document 1 is adopted, it is not possible to maintain the requirement that the pulse energy of the oscillation stage laser (MO) be 1 mJ or greater.

Therefore, in the present invention the MOPO configuration is adopted having an amplification stage laser (PO) provided with a stable resonator that achieves low spatial coherence as the PO resonator. In the case of the MOPO configuration, as shown in FIG. 22, even when the necessary pulse energy from the amplification stage laser (PO) is at least ¼ of that of the conventional MOPA configuration (=discharge width*electrode gap ½), sufficient laser pulse energy can be obtained after amplification.

In the present invention, in the first example of the MOPO configuration, a Fabry-Perot type stable resonator is used as the PO resonator of the amplification stage laser (PO), and the light from the oscillation stage laser (MO) is injected into this resonator. The second example adopts a ring type stable resonator as the PO resonator of the amplification stage laser (PO), and the laser light of the oscillation stage laser (MO) is injected from the output coupler (OC) of the resonator.

In order to achieve a high repetition rate oscillation stage laser (MO) with a narrow discharge width W_{MO}, it is necessary to narrow the discharge electrode width and the electrode gap G_{MO}.

In this case it is possible to maintain a pulse energy of about 0.25 mJ. Furthermore, because the discharge width has been narrowed, a wavelength dispersion element (grating) is disposed in the direction perpendicular to the discharge direction, so that by increasing the expansion ratio of the prism beam expander, it is possible to further narrow the line width.

However, to achieve a high repetition rate amplification stage laser (PO), if the electrode width and the electrode gap G_{PO} are narrowed in order to achieve a narrow discharge width W_{PO}, the following two problems arise.

1. Damage to the Optical Elements of the Resonator of the Amplification Stage Laser (PO)

If the discharge width is reduced to ½, for example, the area of the laser beam is also reduced to less than ½, and assuming the same pulse energy is output (about 17 mJ), the energy density of the laser beam is increased by a factor of two or more.

As a result, damage occurs to the window from which the light is taken out from the laser chamber of the amplification stage laser (PO), or to the optical elements included in the PO resonator that amplifies the laser beam. Therefore, it is difficult to reduce the discharge width and the electrode gap of the PO laser more by than a certain amount.

2. Reduction in Amplification Ratio of the Amplification Stage Laser (PO)

If the discharge area of the amplification stage laser (PO) is reduced, it is not possible to output the necessary pulse energy (for example 17 mJ or greater) as a rating.

Therefore, in the present invention, in order to achieve high pulse energy and to reduce the load on the optical elements of the PO resonator, the configuration adopted is one in which n pairs of electrodes are disposed in the amplification stage laser (PO), each pair of electrodes are connected to its own power supply, the light from the oscillation stage laser (MO) is injected into the PO stable resonator, at least one pair of electrodes are discharged in synchronization with the injected light, and the laser light is output from the amplification stage laser (PO).

The configuration may be one in which a plurality of pairs of discharge electrodes are disposed within the PO resonator of the amplification stage laser (PO), and the oscillation stage laser light is injected into the PO resonator to thereby take the output light out from the PO resonator, or the configuration may be one in which a plurality of amplification stage lasers (PO) is provided, each provided with a PO resonator, and the oscillation stage laser light is split and injected into the PO resonator of each amplification stage laser (PO), and the light output from the PO resonators of the plurality of amplification stage lasers (PO) is merged and output.

By disposing n pairs of electrodes within the amplification stage laser (PO), and discharging at least one pair of electrodes out of the n pairs of electrodes sequentially in synchronization with the injected light output from the oscillation stage laser as described above, the repetition frequency of discharge of each pair of electrodes of the amplification stage laser (PO) can be lower than the repetition frequency of the oscillation stage laser (MO).

In this way, it is possible to configure the relationship between the electrode gap G_{MO} of the oscillation stage laser (MO) and the electrode gap G_{PO} of the amplification stage laser (PO) so that G_{MO}<G_{PO}, and the discharge width W_{PO} of the amplification stage laser (PO) can be larger than the discharge width W_{MO} of the oscillation stage laser (MO).

Here, the electrode gap G_{MO} of the oscillation stage laser (MO) is different from the electrode gap G_{PO} of the amplification stage laser (PO), so if the oscillation stage laser (MO) light is injected into the amplification stage laser (PO) without changing the shape of the beam, the discharge space of the amplification stage laser (PO) will not be filled by the seed light output from the oscillation stage laser (MO).

Therefore, preferably a beam expander that expands the beam in at least the direction of the discharge gap direction is disposed on the light path between the oscillation stage laser (MO) and the amplification stage laser (PO). In this way it is possible to fill the discharge space of the amplification stage laser (PO) with the seed light.

FIGS. 28(a) and 28(b) show an example of a section through the electrode area of the discharge electrodes of an oscillation stage laser (MO) and an amplification stage laser (PO).

By narrowing the electrode width and the electrode gap G_{MO} of the oscillation stage laser (MO), the discharge width W_{MO} is narrowed, so stable 12 kHz discharge is possible.

Also, because the discharge width is narrow, by disposing the dispersion direction of the wavelength dispersion element perpendicular with respect to the discharge, and increasing the expansion ratio of the beam expanding prism, the beam spreading angle of the beam incident on the wavelength dispersion element is reduced, and the spectral width output from the oscillation stage laser (MO) is further narrowed.

However, the laser output of the oscillation stage laser (MO) is reduced by the amount that the beam cross-sectional area is reduced (if the beam cross-sectional area is reduced to ¼ (½ and electrode gap ½), the output reduces from 1 mJ→0.25 mJ).

However, even though the output of the oscillation stage laser (MO) reduces to half or less, because the MOPO configuration is adopted, the expanded beam is injected into the stable resonator of the amplification stage laser (PO), so the PO resonator is sufficiently able to amplify the oscillations and output the light.

Also, by disposing n pairs of electrodes within the amplification stage laser (PO), the repetition frequency of discharge of each pair of electrodes of the amplification stage laser (PO) can be lower than the repetition frequency of the oscillation stage laser (MO), so the cross-sectional area of the discharge by one of the pairs of discharge electrodes can be the same as in the case of conventional comparatively low repetition frequencies, as shown in FIG. 28(b).

Therefore, the load (energy density) on the optical elements used in the PO resonator can be reduced, and the life of the optical elements of the PO resonator can be extended.

Also, by alternately discharging for example two pairs of electrodes by two power supplies in synchronization with the injected light, high repetition rate (12 kHz) and high pulse energy (17 mJ) is possible.

Based on the above, the present invention solves the problems referred to above as follows.

(1) In an injection locked laser device that includes a line narrowed oscillation stage laser and an amplification stage laser having at least one optical stable resonator, an injection device that injects the oscillation stage laser light as injected light to the optical stable resonator of the amplification stage laser is provided, a plurality of pairs of discharge electrodes are disposed in the optical resonator of the amplification stage laser, and the electrode pairs are connected to a power supply circuit for discharging.

Also, at least one pair from among the plurality of pairs of electrodes is successively discharged in synchronization with the injected light.

For example, in the case that two pairs of electrodes are provided, a discharge voltage is applied alternately to the two pairs of electrodes to cause discharge in synchronization with the injected light. Also, in the case that n pairs of electrodes are provided, the n pairs of electrodes are divided into m groups (n>m), a discharge voltage is applied successively to the m groups of pairs of electrodes to cause discharge in synchronization with the injected light, in units of pairs of electrodes belonging to the same group.

(2) In an injection locked laser device that includes a line narrowed oscillation stage laser and at least k amplification stage lasers having an optical stable resonator, an injection device that splits and injects the oscillation stage laser light as injected light to the optical stable resonators of the k amplification stage lasers is provided, and the electrodes of the optical resonators of the k amplification stage laser devices are connected to a power supply circuit for discharging.

Also, at least one of the k amplification stage lasers is successively discharged in synchronization with the injected light.

For example, in the case that two amplification stage lasers having an optical stable resonator are provided, a discharge voltage is applied alternately to the electrodes of the two amplification stage lasers to cause discharge in synchronization with the injected light. Also, in the case where k amplification stage lasers are provided, the k amplification stage lasers are divided into m (k>m) groups, a discharge voltage is applied successively to the m groups of amplification stage lasers to cause discharge in synchronization with the injected light, in units of amplification stage lasers belonging to the same group.

(3) In (1) and (2) above, a beam expander which expands the beam output from the oscillation stage laser in at least the direction of the electrode gap is disposed in the light path between the oscillation stage laser and the amplification stage laser.

Here, the electrode gap of the oscillation stage laser and the amplification stage laser are determined as follows.

As stated above, by narrowing the distance between electrodes (electrode gap), it is possible to narrow the discharge width, and high repetition rates can be achieved accordingly.

Therefore, in order to achieve high repetition rates, it is necessary to narrow the distance between the electrodes (electrode gap) of the oscillation stage laser, but for the amplification stage laser, as stated above, a plurality of pairs of discharge electrodes are disposed in the optical stable resonator of the amplification stage laser, so the repetition frequency of discharge of each pair of electrodes may be less than the repetition frequency of the oscillation stage laser.

Therefore, the electrode gap G_{MO} of the oscillation stage laser (MO) and the electrode gap G_{PO} of each pair of the amplification stage laser (PO) are set so that G_{MO}<G_{PO}.

As stated above, in order to achieve an oscillation stage laser with high repetition rate, the output of the oscillation stage laser is reduced. Therefore, it is preferable that a high efficiency injection device is used as the device for injecting the oscillation stage laser light (seed light) to the optical stable resonator of the amplification stage laser.

As explained above, according to the present invention, the following effects can be obtained.

(1) A MOPO configuration is adopted in which an amplification stage laser (PO) having an optical stable resonator is provided, so it is possible to significantly reduce the pulse energy necessary for the amplification stage laser (PO) compared with the conventional MOPA configuration.

Therefore, by narrowing the electrode width and shortening the electrode gap in order to achieve a high repetition rate oscillation stage laser (MO), the output of the oscillation stage laser (MO) is reduced, but it is possible to provide the necessary pulse energy to the amplification stage laser.

(2) A plurality of pairs of discharge electrodes are disposed within the optical stable resonator of the amplification stage laser device, each pair of electrodes are connected to a power supply circuit, and at least one pair from among a plurality of groups of pairs of electrodes are discharged successively in synchronization with the injected light, so the repetition frequency of each pair of electrodes of the amplification stage laser (PO) can be lower than the repetition frequency of the oscillation stage laser (MO).

Therefore, even though the oscillation stage laser operates at high repetition frequency, the discharge cross-sectional area of one group of electrode pairs of the amplification stage laser (PO) can be made larger than the discharge cross-sectional area of the oscillation stage laser, and equal to the cross-sectional area in the case of conventional comparatively low repetition frequencies.

Therefore, the load (energy density) on the optical elements used in the PO resonator can be reduced, and the life of the optical elements of the PO resonator can be extended.

(3) By disposing a beam expander which expands the beam output from the oscillation stage laser in at least the direction of the electrode gap in the light path between the oscillation stage laser and the amplification stage laser, it is possible to fill the discharge space of the amplification stage laser (PO) with the seed light, which is the light output from the oscillation stage laser, so it is possible to prevent lowering of efficiency, even though the relationship between the electrode gap G_{MO} of the oscillation stage laser (MO) and the electrode gap G_{PO} of each electrode pair of the amplification stage laser (PO) is G_{MO}<G_{PO}.

### BRIEF DESCRIPTION OF THE DRAWINGS

FIG. 1 is a diagram showing the basic constitution of a laser device according to the present invention;

FIGS. 2(a) and 2(b) are diagrams showing the constitution of a laser device according to the first embodiment of the present invention;

FIGS. 3(a) through 3(d) are diagrams showing an example of the constitution of the beam expander;

FIGS. 4(a) and 4(b) are diagrams showing the constitution of a laser device according to the second embodiment of the present invention;

FIGS. 5(a) and 5(b) are diagrams showing the constitution of a laser device according to the third embodiment of the present invention;

FIGS. 6(a) and 6(b) are diagrams showing a modification of the third embodiment of the present invention;

FIGS. 7(a) through 7(c) are diagrams showing the constitution of a laser device according to the fourth embodiment of the present invention;

FIGS. 8(a) through 8(c) are diagrams showing the constitution of a laser device according to the fifth embodiment of the present invention;

FIGS. 9(a) and 9C are diagrams showing the constitution of a laser device according to the sixth embodiment of the present invention;

FIGS. 10(a) and 10(b) are diagrams showing the constitution of a laser device according to the seventh embodiment of the present invention;

FIGS. 11(a) and 11(b) are diagrams showing the constitution of a laser device according to the eighth embodiment of the present invention;

FIGS. 12(a) and 12(b) are diagrams showing the constitution of a laser device according to the ninth embodiment of the present invention;

FIG. 13 is a diagram showing a modification of the ninth embodiment of the present invention;

FIGS. 14(a) and 14(b) are diagrams (1) showing the constitution of a laser device according to the tenth embodiment of the present invention;

FIG. 15 is a diagram (2) showing the constitution of a laser device according to the tenth embodiment of the present invention;

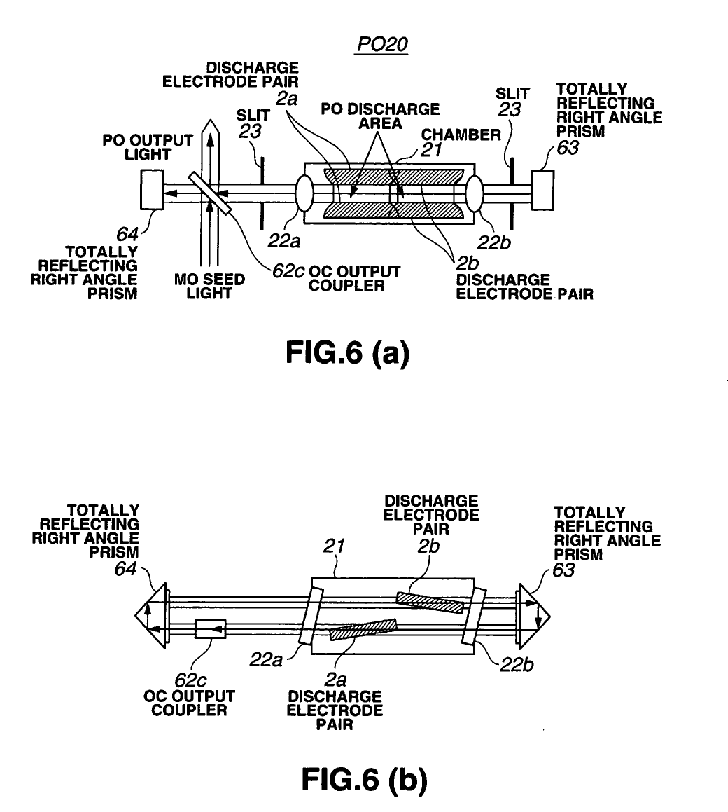

FIGS. 6(a) and 6(b) are diagrams showing the constitution of a laser device according to the eleventh embodiment of the present invention;

FIGS. 17(a) and 17(b) are diagrams showing the constitution of a laser device according to the twelfth embodiment of the present invention;

FIGS. 18(a) through 18(c) are diagrams showing an example of the constitution of the beam merging device;

FIGS. 19(a) and 19(b) are diagrams showing the constitution of a laser device according to the twelfth embodiment of the present invention;

FIGS. 20(a) and 20(b) are diagrams showing an example of the outline configuration of a two stage laser device;

FIGS. 21(a) and 21(b) are diagrams showing the outline constitution of the laser device disclosed in Patent Document 1;

FIG. 22 is a diagram showing the relationship between the injection pulse energy and the pulse energy after amplification in the MOPA and MOPO configurations;

FIG. 23 is a diagram showing a section through the laser chamber of a discharge excitation laser device;

FIG. 24 is a diagram to explain the principle of electrical discharge;

FIG. 25 is a diagram showing the results of measuring the relationship between the relative values of the electrode gap and the electrode width;

FIGS. 26(a) and 26(b) are diagrams showing an example of the constitution of the system for measuring the discharge width W by the Mach-Zhender interferometer;

FIG. 27 is a diagram showing a simple method of measuring the discharge width W; and

FIGS. 28(a) and 28(b) are diagrams diagram showing an example of a section through the electrode area of the discharge electrodes of an oscillation stage laser (MO) and an amplification stage laser (PO).

### DETAILED DESCRIPTION OF THE INVENTION

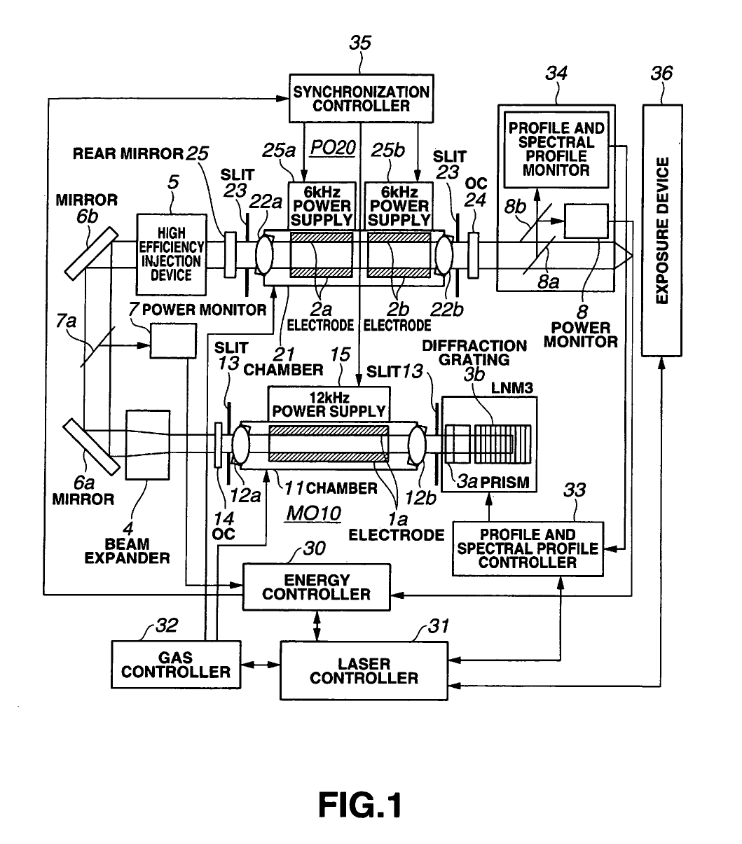

FIG. 1 is a diagram showing the basic constitution of a laser device according to the present invention.

As shown in this figure, the laser device according to the present invention includes an oscillation stage laser (MO) 10 that outputs laser light with a narrow spectral line width, a beam expander 4 that expands the output MO laser light in at least the discharge gap direction, two high reflection (HR) mirrors 6a, 6b for leading the MO laser light into a high efficiency injection device 5, and an amplification stage laser (PO) 20 that amplifies and oscillates the laser light of the oscillation stage laser (MO) 10 using an optical resonator. The MO laser light is injected into the amplification stage 20 at high efficiency by the high efficiency injection device 5. A specific example of a high efficiency injection device is described later. The oscillation stage laser (MO) 10 includes a line narrowing module 3 (hereafter also referred to as LNM3) in which a prism beam expander 3a and a grating (diffraction grating) 3b are mounted, and a laser resonator is constituted by optical elements and an output coupler (OC) 14 within the line narrowing module 3.

Also, a pair of discharge electrodes 1a is provided within a chamber 11, and the electrodes 1a are connected to a power supply 15 that generates a 12 kHz pulse voltage.

The amplification stage laser (PO) 20 includes a stable resonator constituted by an output coupler (OC) 24, a laser chamber 21, and a rear mirror 25, and includes two pairs of electrodes within the chamber 21, namely a pair of electrodes 2a, and a pair of electrodes 2b. The two pairs of electrodes 2a, 2b are connected to power supplies 25a, 25b respectively, that generate 6 kHz pulse voltages.

Here, the relationship between the gap G_{MO} of the pair of electrodes 1a (the gap between the electrodes) of the oscillating stage laser (MO) 10 and the gaps G_{PO} of the two pairs of electrodes 2a, 2b of the amplification stage laser (PO) 20 is set so that G_{MO}<G_{PO}, also, the electrode width W_{PO} of the amplification stage laser (PO) 20 is set greater than the electrode width W_{MO} of the oscillation stage laser (MO) 10.

By setting the gap G_{MO} of the pair of electrodes 1a of the oscillation stage laser (MO) 10 to be narrow, and realizing a narrow electrode width W_{MO}, it is possible to achieve an oscillation stage laser (MO) 10 with a high repetition rate as stated above.

Also, by disposing two pairs of electrodes in the amplification stage laser (PO) 20, and alternately discharging one pair of the electrodes 2a, 2b, it is possible to make the repetition frequency of each of the electrodes in the amplification stage laser (PO) 20 equal to ½ the repetition frequency of the oscillating stage laser (MO) 10, and to increase the cross-sectional area of discharge by one set of discharge electrodes from among the discharge electrodes to be greater compared with that of the oscillation stage laser (MO) 10. Therefore, it is possible to reduce the energy density of the optical elements used in the PO resonator of the amplification stage laser (PO) 20.

Both the oscillation stage laser (MO) 10 and the amplification stage laser (PO) 20 have within their chambers 11, 21 windows 12a, 12b and 22a, 22b disposed in the light axis at both ends of the pair of electrodes 1a and the two pairs of electrodes 2a, 2b respectively, and slits 13, 23 are disposed at both sides for wave form shaping.

A wavelength and spectral profile monitor 34 and a power monitor 8 measures the light quality and the pulse energy of the light output from the amplification stage laser (PO) 20, and a power monitor 7 measures the pulse energy of the oscillation stage laser (MO) 10.

A wavelength and spectral profile controller 33 controls the wavelength and spectral profile of the laser light emitted from the amplification stage laser (PO) based on the output of the wavelength and spectral profile monitor 34. Also, an energy controller 30 controls the pulse energy of the laser based on the power monitors 7, 8.

Also, a gas controller 32 controls the laser gas of the oscillating stage laser (MO) 10 and the amplification stage laser (PO) 20. A laser controller 31 controls the laser overall. A synchronization controller 35 controls the discharge timing of the two 6 kHz power sources 25a, 25b connected to the amplification stage laser (PO) 20 and the 12 kHz power source 15 connected to the oscillation stage laser (MO) 10.

As stated above, the oscillation stage laser (MO) 10 has an LNM3 that includes the prism beam expander 3a and the grating (diffraction grating) 3b, and the direction of dispersion of the grating (diffraction grating) 3b disposed in the LNM3 (=the beam expansion direction of the prism) is disposed in a direction perpendicular to the discharge direction of the electrodes.

A buffer gas and Ar gas and F₂ gas fill the laser chamber 11, and by narrowing the electrode width and the electrode gap, the discharge width becomes narrower, and the gas flow rate between the electrodes increases, so stable discharge can be formed by applying a voltage to the electrodes from the 12 kHz power source to cause discharge.

The excimer ArF is formed by excitation by the discharge. When Ar and F are separated from this ArF excimer, light of wavelength 193 nm is emitted.

By selecting light of wavelength 193 nm in the LNM3, the spectral width is narrowed from about 400 pm to 0.1 pm, and the light is output from the output coupler (OC) 14 of the oscillation stage laser (MO) 10. Pulses are generated at a repetition frequency of 12 kHz from the oscillation stage laser (MO). The time width of the laser light emission pulses of the oscillation stage laser (MO) is about 30 ns.

Next, the light output from the oscillation stage laser (MO) 10 enters the beam expander 4, is expanded and output, in order that the light output from the oscillation stage laser (MO) 10 will have the same beam width as the electrode gap of the amplification stage laser (PO) 20, and then enters the high efficiency injection device 5 by the two high reflection (HR) mirrors 6a, 6b. However, a beam splitter 7a and the power monitor 7 are disposed between the two mirrors 6a, 6b to monitor the pulse energy of the oscillation stage laser (MO) 10.

The value of the pulse energy of the oscillation stage laser (MO) 10 measured here is input to the energy controller 30. Based on the measured value of the pulse energy of the oscillation stage laser (MO) 10, the energy controller 30 sends a control signal to the 12 kHz power supply 15 via the synchronization controller 35.

The laser light output from the high efficiency injection device 5 is injected into the stable resonator constituted by the output coupler (OC) 24 of the amplification stage laser (PO) 20, the laser chamber 21, and the rear mirror 25.

Within the laser chamber 21, the two pairs of electrodes 2a, 2b (hereafter also referred to as the electrode pairs 2a, 2b) are disposed in series, and each of the electrode pairs 2a, 2b is connected to their respective 6 kHz power supply 25a, 25b.

When the injected light emitted from the oscillation stage laser (MO) 10 at 12 kHz is injected into the optical resonator of the amplification stage laser (PO) 20, the synchronized 6 kHz power supplies 25a, 25b are operated alternately, and alternately their respective electrode pairs 2a, 2b are discharged, the injected light is amplified and oscillated within the optical resonator, and the amplified 12 kHz laser light is emitted from the output coupler (OC) 24, and output to an exposure device 36.

This output light is sampled using beam splitters 8a, 8b, the pulse energy is measured by the power monitor 8, and the result is transmitted to the energy controller 30.

Based on the measured results, the energy controller 30 sends control signals to each of the 6 kHz power supplies 25a, 25b of the amplification stage laser (PO) 20, and the 12 kHz power supply 15 of the oscillation stage laser (MO) 10 via the synchronization controller 35.

The light output from the amplification stage laser (PO) 20 is sampled by the beam splitters 8b, 8b, and the wavelength and the spectral profile are measured by the wavelength and the spectral profile monitor 34.

The measured results are transmitted to the wavelength and the spectral profile controller 33, and the wavelength is controlled by sending a control signal to an incident angle variation mechanism (not shown on the drawings) of the grating 3b within the LNM3.

Also, the spectral profile can be controlled by controlling the optical wave front of optical elements (not shown in the drawings) in the optical resonator of the oscillation stage laser (MO) 10. Furthermore, the spectral profile can also be controlled by controlling the concentration of F₂ gas within the laser chamber 11 of the oscillation stage laser (MO) 10 by the gas controller 32.

The laser controller 31 causes the gas controller 32 to replenish and discharge the laser gas (F₂, Ar, and buffer gas), from the variation with time of the applied voltage of the 12 kHz power source 15, the applied voltages of the two 6 kHz power sources 25a, 25b, and the pulse energies of the amplification stage laser (PO) 20 and the oscillation stage laser (MO) 10.

Incidentally, the electrode width and electrode gap of the oscillation stage laser (MO) 10 are narrow, so distortion of the optical wave front due to sound waves occurs, which adversely affects the spectral profile. A method to significantly reduce the effect of the sound waves on the 12 kHz oscillations of the oscillation stage laser (MO) 10 is to use either helium gas or a mixture of Ne and He gases as the buffer gas.

A problem point in using He gas as the buffer gas is that the pulse energy of the oscillation stage laser (MO) is reduced. However, this problem of low pulse energy can be avoided by adopting a high injection efficiency MO amplification stage laser (PO) configuration.

As described above, the laser device according to the present invention adopts the MOPO configuration with an amplification stage laser (PO) 20 having a stable resonator, so even if the output of the oscillation stage laser (MO) 10 is small, it is possible to supply the necessary pulse energy to the amplification stage laser.

Also, by disposing the beam expander 4, which expands the beam output from the oscillation stage laser in at least the direction of the electrode gap, in the light path between the oscillation stage laser (MO) 10 and the amplification stage laser (PO) 20, it is possible to fill the discharge space of the amplification stage laser (PO) 20 with the seed light, which is the light output from the oscillation stage laser (MO) 10, so it is possible to prevent lowering of efficiency.

The following are explanations of examples of the constitution of specific laser devices according to the present invention.

### (1) FIRST EMBODIMENT

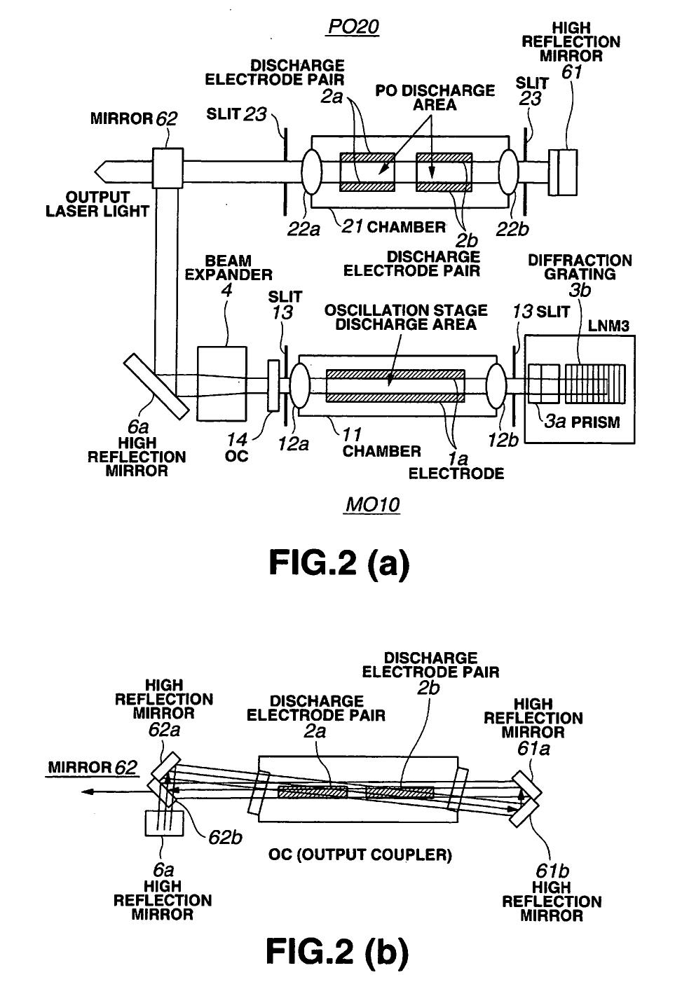

FIGS. 2(a) and 2(b) are diagrams showing the constitution of a laser device according to the first embodiment of the present invention, showing an example of a configuration in which a ring resonator is disposed within the stable resonator of the amplification stage laser (PO), so that the MO laser light (seed light) is efficiently injected into the amplification stage laser (PO).

FIG. 2(a) shows a side view, and FIG. 2(b) shows a top view of the amplification stage laser (PO) 20. In these diagrams, the various measuring equipment, controllers, power sources, and so on, shown in FIG. 1 are omitted.

In FIGS. 2(a) and 2(b), a voltage is applied to the pair of electrodes 1a of the oscillation stage laser (MO) 10 to cause discharge, as described above, and light with a wavelength of 193 nm is emitted. The spectrum of this 193 nm light is narrowed in the LNM3, and output from the OC (output coupler) 14.

The light output by the oscillation stage laser (MO) 10 is expanded by the beam expander 4 to the width of the discharge gap of the amplification stage laser (PO) 20, and injected into the ring resonator of the amplification stage laser (PO) 20 via the high reflection mirror 6a. In other words, as shown in FIG. 2(b), the seed light reflected by the high reflection mirror 6a passes through an OC (output coupler) 62b which is a partially reflection mirror, and is injected into the resonator of the ring resonator.

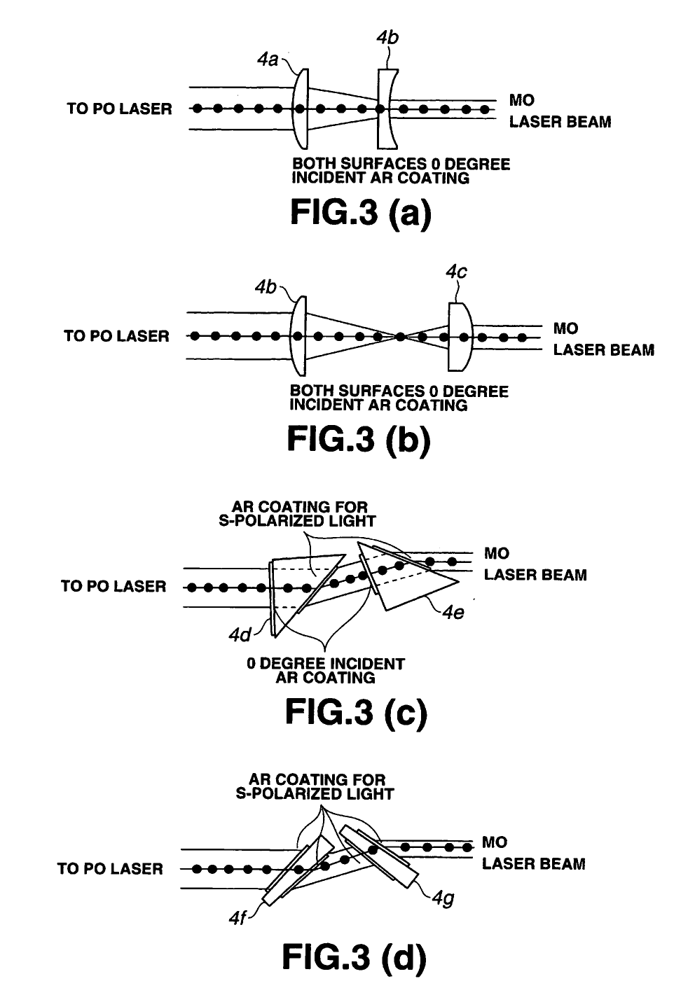

FIGS. 3(a) through 3(d) show an example of the constitution of the beam expander 4. FIG. 3(a) shows an example using a cylindrical concavo-convex lens 4a, 4b with both sides coated with zero degree incident anti-reflection (AR) coating, after the light output from the oscillation stage laser (MO) 10 enters the cylindrical concave lens 4a, it enters the cylindrical convex lens 4b, and the beam diameter is expanded in the direction of the discharge gap of the amplification stage laser (PO) 20.

FIG. 3(b) shows an example using cylindrical convex lenses 4b, 4c with both sides coated with zero degree incident anti-reflection (AR) coating, FIG. 3(c) shows an example using a prism beam expander 4d, 4e with an AR coating with respect to s-polarized light on the incident surface and zero degree AR coating on the exit surface, FIG. 3(d) shows the case where wedge substrates 4f, 4g with AR coating with respect to s-polarized light on both surfaces are used, in all of these configurations it is possible to expand the beam in the discharge gap direction of the amplification stage laser (PO) 20, the same as for FIG. 3(a). In the examples in FIGS. 3(c) and 3(d), the reason that AR coating with respect to s-polarized light is necessary on the sloping surfaces of the prisms or the wedges is because the state of the polarized light output from the MO laser is linear polarization perpendicular to the plane of the paper.

Returning to FIGS. 2(a) and 2(b), the seed light that has passed through the OC 62b is obliquely incident on the discharge gap of the laser chamber by a high reflection mirror 62a.

A voltage from a 6 kHz power supply, which is not shown in the drawings, is applied to the electrode pair 2a of the amplification stage laser (PO) in synchronization with the seed light, and discharge is caused. In this way, the seed light that passed through the discharge gap is amplified, passes through the chamber 21, is bent back by two high reflection mirrors 61a, 61b, and again is led into the discharge space which is discharging, and is amplified.

Part of the amplified light passes through the OC 62b and is output as laser light, and the reflected light of the OC 62b is again fed back into ring resonator and resonated. It is then output as a laser pulse.

If the reflectance of the OC 62b is 20% to 30%, then the injection efficiency is 80% to 70%, so a high injection efficiency can be obtained.

Next, when the seed pulse light is injected, a voltage is applied to the discharge electrode pair 2b of the amplification stage laser (PO) 20 and discharge occurs in synchronization with the seed pulse light. In this way, the seed light is amplified and output as a pulse of output laser light by the ring resonator, the same as described above.

In this way as described above, it is possible to achieve high repetition rate (10 kHz or higher) and high pulse energy output by providing at least two sets of pairs of discharge electrode pairs 2a, 2b within one ring resonator, and alternately discharging the electrode pairs of the amplification stage laser (PO) 20 in synchronization with the input of the seed light.

Also, in this embodiment, the laser light was returned to the laser chamber 21 by two high reflection mirrors 61a, 61b, but the same function can be achieved by returning the light by Fresnel reflection (total internal reflection) using a total reflecting prism whose angle is somewhat smaller than 45 degrees (a few mrad).

### (2) SECOND EMBODIMENT

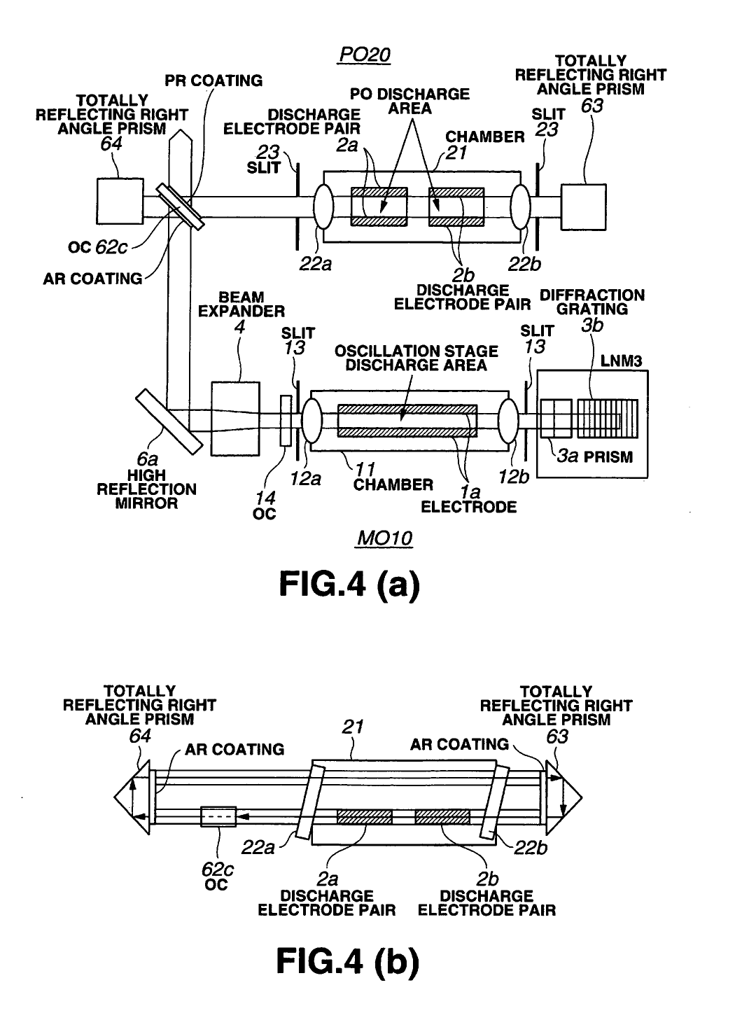

FIGS. 4(a) and 4(b) are diagrams showing the constitution of a laser device according to the second embodiment of the present invention, showing an example of configuration in which a total internal reflection right angle prism ring resonator is disposed within the stable resonator of the amplification stage laser (PO), so that the MO laser light (seed light) is efficiently injected into the amplification stage laser (PO).

FIG. 4(a) shows a side view, and FIG. 4(b) shows a top view of the amplification stage laser (PO) 20. In these diagrams, the various measuring equipment, controllers, power sources, and so on, shown in FIG. 1 are omitted.

As stated previously, the seed light is output from the OC (output coupler) 14 of the oscillation stage laser (MO) 10. The beam of light output by the oscillation stage laser (MO) 10 is expanded by the beam expander 4 to the width of the electrode gap of the amplification stage laser (PO) 20. Then the seed light enters an OC (output coupler) 62c of the amplification stage laser (PO) 20 by a high reflection mirror 6a, where it is reflected, and the seed light is injected into the resonator of the ring resonator.

The OC 62c, which is coated with partially reflection (PR) and anti-reflection (AR) coating, partially reflects the seed light and makes it incident on a total internal reflection right angle prism 64. The total internal reflection right angle prism 64 is coated with anti-reflection (AR) coating on the input and output surfaces. The seed light is totally reflected by Fresnel reflection on the two surfaces of the prism 64, passes a slit 23 and a window 22a of the amplification stage laser (PO) 20, and enters the laser chamber 21.

As shown in FIG. 4(b), the seed light passes the discharge electrode pairs 2a, 2b of the amplification stage laser (PO) 20 with the axis of the light approximately parallel to the discharge electrode pairs 2a, 2b, passes through the chamber 21 without being amplified, and enters a total internal reflection right angle prism 63. The seed light is totally reflected by the two surfaces of the right angle prism 63, and is again injected into the laser chamber 21 via a window 22b, so that the discharge space of the discharge electrodes 2a, 2b coincides with the light axis.

A voltage is applied to the discharge electrode pairs 2a, 2b in synchronization with the seed light, as stated previously, and discharge is caused. Then, the seed light that passes through the discharge gap is amplified, passes through the chamber 21, and again is injected into the OC 62c. Part of the amplified light is reflected by the OC 62c and is output as laser, and the reflected light of the OC 62c is again returned to the ring resonator as feedback light. In this way the amplification stage laser (PO) 20 amplifies the oscillations.

If the reflectance of the OC is 70% to 80%, then the injection efficiency is 70% to 80%, so a high injection efficiency can be obtained.

When the next seed pulse light is injected, a voltage is applied to the discharge electrode pair 2b of the amplification stage laser (PO) 20 and discharge occurs in synchronization with the seed pulse light. In this way, the seed light is amplified and output as a pulse of output laser light by the ring resonator, the same as described above.

In this way as described above, it is possible to achieve high repetition rate (10 kHz or higher) and high pulse energy output by providing at least two pairs of discharge electrodes 2a, 2b within one ring resonator, and alternately discharging the electrode pairs of the amplification stage laser (PO) 20 in synchronization with the input of the seed light.

Also, the merit of the present embodiment is that the ring resonator is constituted by two right angle total reflecting prisms, and the OC 62c is disposed on the light axis of the ring resonator, so alignment of the light axis of the ring resonator is simple, and operation is stable.

### (3) THIRD EMBODIMENT

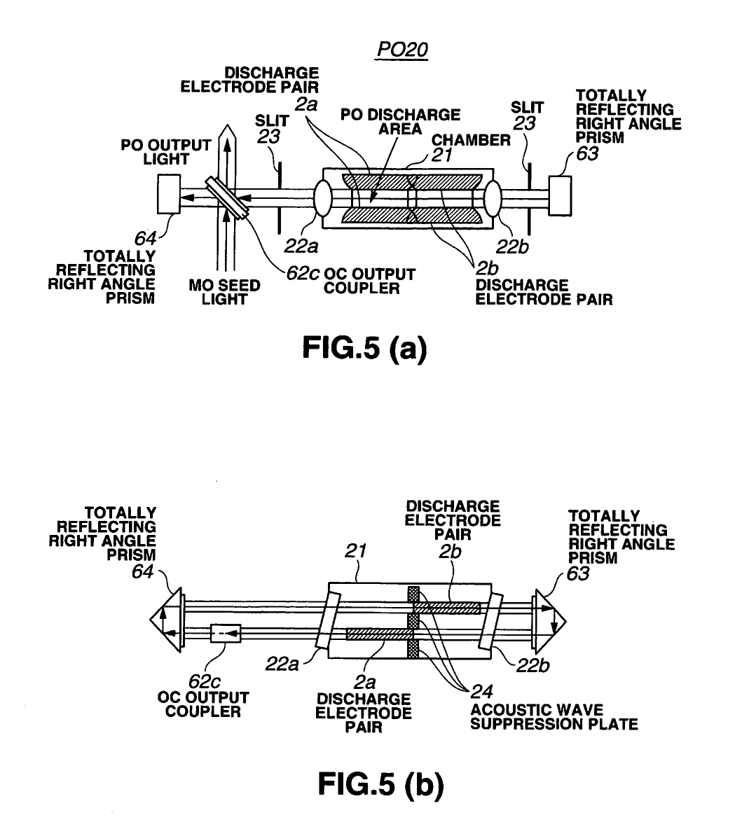

FIGS. 5(a) and 5(b) are diagrams showing the constitution of a laser device according to the third embodiment of the present invention, showing another example of amplification stage laser (PO) using a ring resonator. In the present embodiment, the electrode pairs are not arranged in a line as in the embodiment shown in FIGS. 4(a) and 4(b), but are arranged on mutually different light axes in the ring resonator. FIG. 5(a) shows a side view of the amplification stage laser (PO), and the oscillation stage laser 10 is omitted in this diagram, but the oscillation stage laser 10 has the same constitution as that shown in FIG. 4(a). Also, FIG. 5(b) shows a top view of the amplification stage laser (PO) 20. In these diagrams, the various measuring equipment, controllers, power sources, and so on, shown in FIG. 1 are omitted.

The output light of the oscillation stage laser (MO) 10 is expanded by a beam expander to the width of the electrode gap of the PO resonator as shown in FIGS. 4(a) and 4(b), enters the OC (output coupler) 62c of the amplification stage laser (PO) by a high reflection mirror, where it is reflected, and the seed light is injected into the ring resonator of the amplification stage laser (PO) 20.

The OC 62c, which is coated with partially reflection (PR) and anti-reflection (AR) coating, partially reflects the seed light and makes it incident on a total internal reflection right angle prism 64. The total internal reflection right angle prism 64 is coated with anti-reflection (AR) coating on the input and output surfaces.

The seed light is totally reflected by Fresnel reflection on the two surfaces of the prism 64, passes the window 22a, and is injected into the laser chamber 21 so that the discharge space of the electrode pair 2b inside the chamber 21 coincides with the light axis. The seed light passes through the discharge space of the electrode pairs 2a, 2b, and enters the total internal reflection right angle prism 63.

The seed light is totally reflected by the two surfaces of the right angle prism 63, and again enters the laser chamber 21 via the window 22b, so that the discharge space of the discharge electrode pair 2a coincides with the light axis.

A voltage is applied to the discharge electrode pair 2a in synchronization with the seed light, and discharge is caused. Then, the seed light that passes through the discharge gap is amplified, passes through the chamber 21, and again enters the OC 62c. Part of the amplified light is reflected by the OC 62c and is output as laser, and the reflected light of the OC 62c is again returned to the ring resonator as feedback light.

In this way the amplification stage laser (PO) 20 amplifies the oscillations. If the reflectance of the OC 62c is 70% to 80%, then the injection efficiency is 70% to 80%, so a high injection efficiency can be obtained, also the discharge electrode pair 2b is discharged in synchronization with the next seed pulse light, the oscillations are amplified by the ring resonator the same as above, and the light is output as a pulse of output laser light.

In this way as described above, it is possible to achieve high repetition rate (10 kHz or higher) and high pulse energy output by providing at least two groups of pairs of discharge electrodes 2a, 2b within one ring resonator, and alternately discharging the electrode pairs 2a, 2b of the amplification stage laser (PO) 20 in synchronization with the input of the seed light.

Also, the merit of this embodiment is that because the divided electrode pairs can be differently disposed with respect to each other, a distance is provided between the alternately discharging electrodes, and this has the following effects.

(i) Insulation distance is provided, so faulty discharge does not occur.

(ii) By alternately discharging, the effect of sound waves can be reduced.

(iii) The gain length can be increased, so the output efficiency of the amplification stage laser (PO) 20 can be improved, and the amplification stage laser (PO) 20 can be made compact.

Here, it is possible to reduce the effect of sound waves of the alternate discharge by disposing a acoustic wave suppression plate 24 as shown in FIG. 5(b). As an example of the acoustic wave suppression plate 24, a porous sound absorption material (porous alumina, fibrous alumina, and so on) may be used.

### (4) MODIFICATION OF THE THIRD EMBODIMENT

FIGS. 6(a) and 6(b) are diagrams showing the constitution of a modification of the third embodiment of the present invention, showing another example of amplification stage laser (PO) using a ring resonator. The present embodiment shows an example in which the electrode pairs are disposed on mutually different light paths in the ring resonator in the embodiment of FIGS. 4(a) and 4(b), and are inclined with respect to the axis of the light.

The rest of the constitution is the same as that of the third embodiment shown in FIGS. 5(a) and 5(b), and the operation is also the same. FIG. 6(a) shows a side view of the amplification stage laser (PO), and FIG. 6(b) shows a top view of the amplification stage laser (PO) 20.

By configuring the present embodiment in this way, the following effects can be obtained.

(i) Because the electrodes are separated, it is possible to reduce the effect of sound waves due to the alternate discharging.

(ii) The beam width can be broadened, so the load on the optical elements is reduced, and the life of the optical elements is extended.

### (5) FOURTH EMBODIMENT

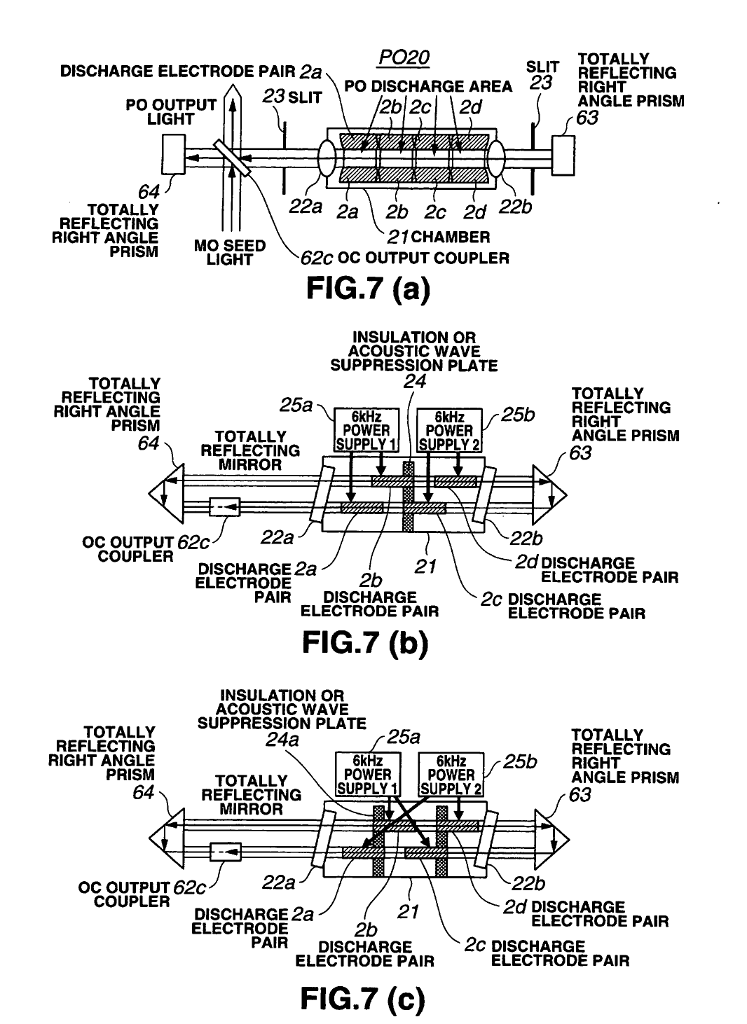

FIGS. 7(a) through 7(c) are diagrams showing the constitution of a laser device according to the fourth embodiment of the present invention, showing another example of amplification stage laser (PO) using a ring resonator. The present embodiment is an example in which the electrode pairs are divided into four in the embodiment shown in FIGS. 5(a) and 5(b), and are arranged on mutually different light axes in the ring resonator.

FIG. 7(a) shows a side view of the amplification stage laser (PO), and the oscillation stage laser 10 is omitted in this diagram, but the oscillation stage laser 10 has the same constitution as that shown in FIG. 4(a). Also, FIGS. 7(b) and 7(c) show top views of the amplification stage laser (PO) 20.

As shown in this figure, in the present embodiment, the electrodes are divided into four discharge electrode pairs 2a through 2d, the electrode pairs 2a, 2c are disposed on one of the light paths in the ring resonator, and the electrode pairs 2b, 2d are disposed on the other light path. The rest of the constitution is the same as that shown in FIGS. 5(a) and 5(b).

In the embodiment shown in FIG. 7(b), the discharge electrode pairs 2a, 2b are connected to a 6 kHz power supply 25a, and the electrode pairs 2c, 2d are connected to another 6 kHz power supply 25b.

Also, the 6 kHz power supply 25a and the 6 kHz power supply 25b are alternately discharged in synchronization with the seed light.

In this case, the electrode pairs 2a, 2b are connected to the 6 kHz power supply 25a, so by discharging at the same time in synchronization with the seed light, the seed light is amplified by the ring resonator, and the first pulse of light is output from the OC 62c, and the 6 kHz power supply 25b applies a voltage to discharge the electrode pairs 2b, 2d in synchronization with the next pulse of seed light, the seed light is amplified by the ring resonator, and the second pulse of light is output from the OC 62c.

FIG. 7(c) shows an example in which the 6 kHz power supply 25a is connected to the electrode pairs 2b and 2c, and the 6 kHz power supply 25b is connected to the electrode pairs 2a and 2d.

The merit of these embodiments is that the variation in the light quality (beam profile, beam divergence, and so on) of the first and second pulses of light is reduced by alternately discharging the amplification stage laser (PO) 20.

In this embodiment two power supplies to which four pairs of discharge electrodes are connected are alternately operated, but there is no limitation to the number of divisions of the electrodes in this embodiment, and by connecting four or more pairs of discharge electrodes to two power supplies and operating the power supplies alternately, the variation in the light quality of the first and second pulses is further reduced.

### (6) FIFTH EMBODIMENT

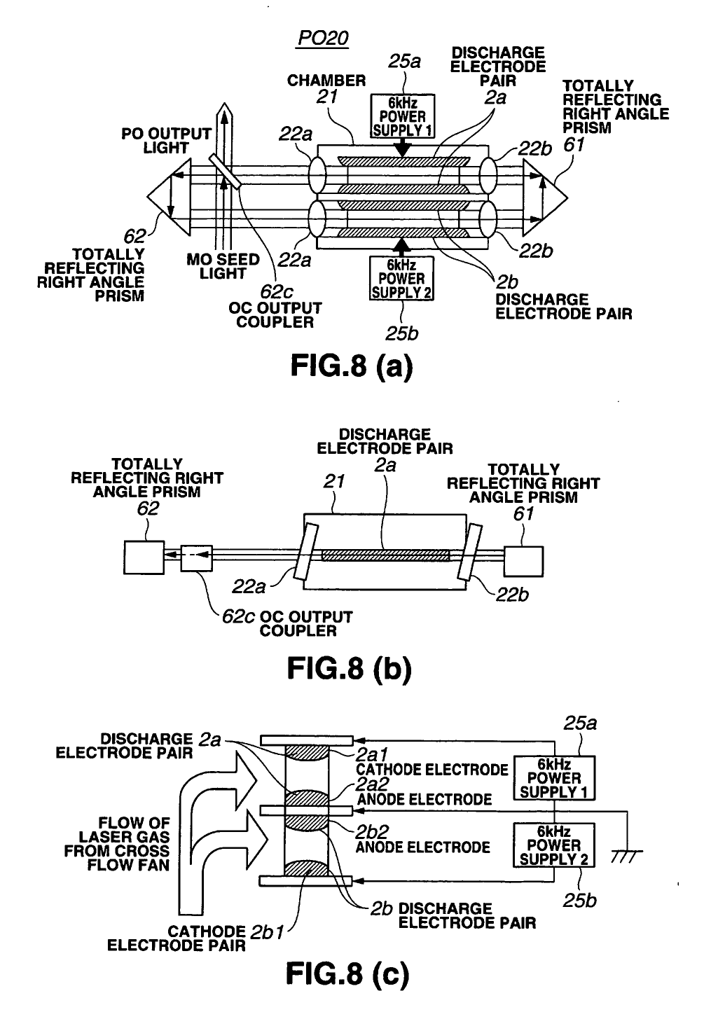

FIGS. 8(a) through 8(c) are diagrams showing the constitution of a laser device according to the fifth embodiment of the present invention, showing another example of amplification stage laser (PO) using a ring resonator. The present embodiment is an embodiment in which the ring resonator is constituted by, in the embodiment of FIGS. 5(a) and 5(b), two pairs of discharge electrodes disposed within the laser chamber of the amplification stage laser (PO) 20 in the vertical direction with respect to the cross-sectional direction of the chamber, and the discharge electrode pairs are connected to their respective 6 kHz power sources.

FIG. 8(a) shows a side view of the amplification stage laser (PO), and the oscillation stage laser 10 is omitted in this diagram, but the oscillation stage laser 10 has the same constitution as that shown in FIG. 4(a). FIG. 8(b) shows a top view of the amplification stage laser (PO) 20, and FIG. 8(c) shows an example of the connection of the two discharge electrode pairs and the 6 kHz power supplies.

In FIG. 8(a), the discharge electrode pair 2a is connected to the 6 kHz power supply 25a, and the electrode pair 2b is connected to the 6 kHz power supply 25b. Also, the 6 kHz power supply 25a and the 6 kHz power supply 25b are alternately discharged in synchronization with the seed light. In this case, the electrode pair 2a is connected to the 6 kHz power supply 25a, so by discharging at the same time in synchronization with the seed light, the seed light is amplified by the ring resonator, and the first pulse of light is output from the OC 62c, and the 6 kHz power supply 25b applies a voltage to discharge the electrode pair 2b in synchronization with the next pulse of seed light, the seed light is amplified by the ring resonator, and the second pulse of light is output from the OC 62c.

FIG. 8(c) shows an example in which the 6 kHz power supply 25a is connected to the electrode pair 2a, and the 6 kHz power supply 25b is connected to the electrode pair 2b. By connecting the center portion of the discharge unit to ground, and disposing the anode electrode 2a2 of the discharge electrode pair 2a and the anode electrode 2b2 of the discharge electrode pair 2b back to back, it is possible to obtain a long electrode length.

In the present embodiment, by dividing the electrodes of the amplification stage laser (PO) 20 in the vertical direction and disposing the electrodes in the light path of the ring resonator, the following effects can be obtained.

(i) Faulty discharge does not occur during alternate operation.

(ii) By alternately discharging, the effect of sound waves can be reduced.

(iii) The gain length can be increased to be similar to the length of the chamber, so it is possible to obtain high efficiency and compactness.

### (7) SIXTH EMBODIMENT

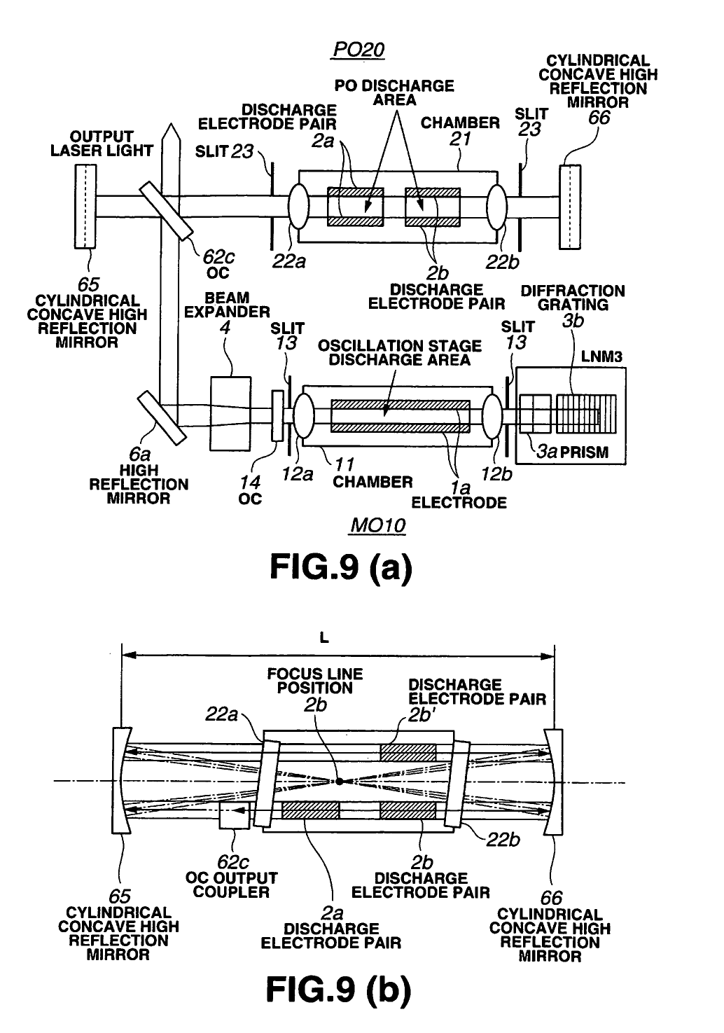

FIGS. 9(a) and 9(b) are diagrams showing the constitution of a laser device according to the sixth embodiment of the present invention, showing an example in which the ring resonator is constituted by disposing two cylindrical high reflection concave mirrors in opposition as the resonator of the amplification stage laser (PO). FIG. 9(a) shows a side view of the present embodiment, and FIG. 9(b) shows a top view of the amplification stage laser (PO) 20.

The present embodiment is obtained by changing the constitution of the resonator of the amplification stage laser (PO) 20 in the embodiment of FIGS. 4(a) and 4(b) as shown in FIG. 9(b), and the rest of the constitution and the operation is the same.

As shown in FIG. 9(b), the optical resonator includes cylindrical high reflection mirrors 65 and 66 disposed in opposition. The radius of curvature R of the cylindrical high reflection mirrors 65 and 66 is equal to the distance L between the high reflection mirrors 65, 66, and the two mirrors 65, 66 are disposed so that the positions of their focal points coincide.

First, seed light from the oscillation stage laser (MO) 10 that has been expanded by the beam expander 4 enters the OC output coupler (partially reflection mirror) 62c of the amplification stage laser (PO) 20. Seed light from the OC 62c that has been reflected at 45 degrees enters the cylindrical concave high reflection mirror 65 and is reflected, passes the window 22a and enters the laser chamber 21, and is focused on the line at the position of the focal point at the center line of the two concave mirrors in the chamber 21.

This focused light passes through a broadening window 22b, is reflected by the cylindrical high reflection mirror 66, and the seed light is collimated.

This collimated light again passes through the laser chamber 21, is reflected by the cylindrical high reflection mirror 65, passes through the window 22a, and is focused on the line at the position of the focal point of the two mirrors in the laser chamber 21. This focused light passes through the window 22b while broadening, is again reflected by the cylindrical high reflection mirror 66, and again is collimated. Then the collimated light is passed between the discharge electrode pairs 2b and 2a and is amplified, and again returns to the OC 62c.

Light that is partially reflected by the OC 62c is output as output laser light. Also, light that has passed through the OC 62c is again returned to the optical resonator as feedback light.

The discharge electrode pair 2a is connected to the 6 kHz power supply 25a (not shown in the drawings) as stated above, and the electrode pair 2b is connected to the other 6 kHz power supply 25b (not shown in the drawings). Also, the 6 kHz power supply 25a and the 6 kHz power supply 25b are alternately discharged in synchronization with the seed light. In this way, it is possible to obtain high pulse energy at high repetition rate (10 kHz or higher).

In this case, the electrode pair 2a is connected to the 6 kHz power supply 25a, so by discharging at the same time in synchronization with the seed light, the seed light is amplified by the ring resonator, and the first pulse of light is output from the OC 62c, and the 6 kHz power supply 25b applies a voltage to discharge the electrode pair 2b in synchronization with the next pulse of seed light, the seed light is amplified by the ring resonator, and the second pulse of light is output from the OC 62c.

The electrode pairs should be located where the collimated light passes, for example, instead of the position of the discharge electrode pair 2, the discharge electrode pair 2b′ position in FIG. 9(b) may be used.

The present embodiment has been explained by showing the example of two convex mirrors, but four convex mirrors may be used in a similar constitution.

In this embodiment, light is focused on the focal line by adopting cylindrical concave high reflection mirrors, so optical elements (windows) are not provided in high density in the center of the laser chamber, so degradation of the optical elements or the occurrence of breakdown at the focal point does not occur, so stable laser oscillation is possible.

### (8) SEVENTH EMBODIMENT

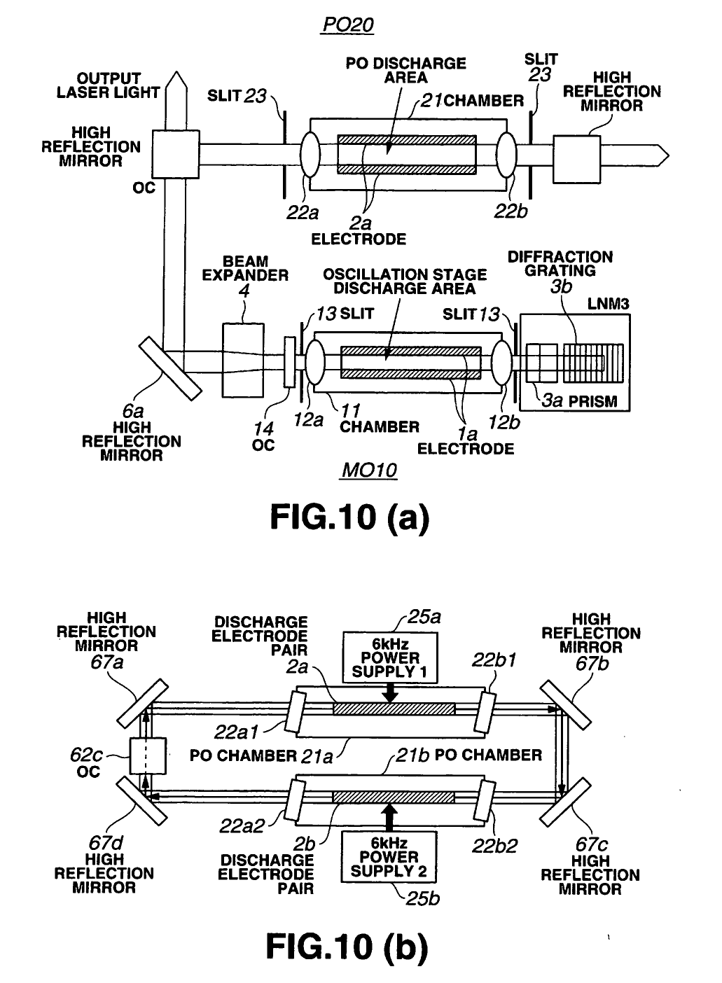

FIGS. 10(a) and 10(b) are diagrams showing the constitution of a laser device according to the seventh embodiment of the present invention, showing an example in which a ring resonator is used as the amplification stage laser (PO), and there is a plurality of amplification stage laser (PO) chambers. FIG. 10(a) shows a side view of the present embodiment, and FIG. 10(b) shows a top view of the amplification stage laser (PO) 20.

The present embodiment is obtained by changing the constitution of the resonator of the amplification stage laser (PO) 20 in the embodiment of FIGS. 4(a) and 4(b) as shown in FIG. 10(b), and the rest of the constitution and the operation is the same.

In FIG. 10(b), the ring resonator is constituted by four high reflection mirrors 67a, 67b, 67c, and 67d, two PO chambers 21a and 21b are disposed on the light axes of these ring resonators, and the discharge electrode pairs 2a, 2b are disposed within the two PO chambers 21a and 21b respectively.

First, seed light from the oscillation stage laser (MO) 10 that has been expanded by the beam expander 4 enters the OC output coupler (partially reflection mirror) OC 62c of the amplification stage laser (PO) 20. Seed light that has been reflected at 45 degrees from the OC 62c is incident on and reflected by the high reflection mirror 67a, and enters the PO chamber 21a. The seed light passes between the discharge electrode pair 2a of the PO chamber 21a, is amplified when the discharge electrode pair 2a is discharged in synchronization with the seed light, then the light enters the PO chamber 21b by the high reflection mirrors 67b and 67c.

Then the light is passed between the discharge electrode pair 2b, passed through the PO chamber 21b, is reflected by the high reflection mirror 67d, and again returned to the OC 62c. Light that is partially reflected by the OC 62c is output as output laser light. Light that has passed through the OC 62c is again returned to the optical resonator as feedback light.

The 6 kHz power supply 25a is mounted on the PO chamber 21a, and the 6 kHz power supply 25b is mounted on the PO chamber 21b. Also, the 6 kHz power supply 25a and the 6 kHz power supply 25b are alternately discharged in synchronization with the seed light.

In this case, the electrode pair 2a is connected to the 6 kHz power supply 25a, so by discharging at the same time in synchronization with the seed light, the seed light is amplified by the ring resonator, and the first pulse of light is output from the OC 62c. Also, the 6 kHz power supply 25b applies a voltage to discharge the electrode pair 2b in synchronization with the next pulse of seed light, the seed light is amplified by the ring resonator, and the second pulse of light is output from the OC 62c. In this way, it is possible to obtain high pulse energy at high repetition rate (10 kHz or higher).

The merit of the present embodiment is that a compact laser device can be obtained by disposing the two PO chambers in parallel. Also, a PO chamber is disposed on the light axis of a single ring resonator, so the position at which the seed light is injected and the position at which the laser light is output from the OC are one position each respectively, so there is no necessity to split the seed light and re-merge the output laser light from each amplification stage laser (PO).

### (9) EIGHTH EMBODIMENT

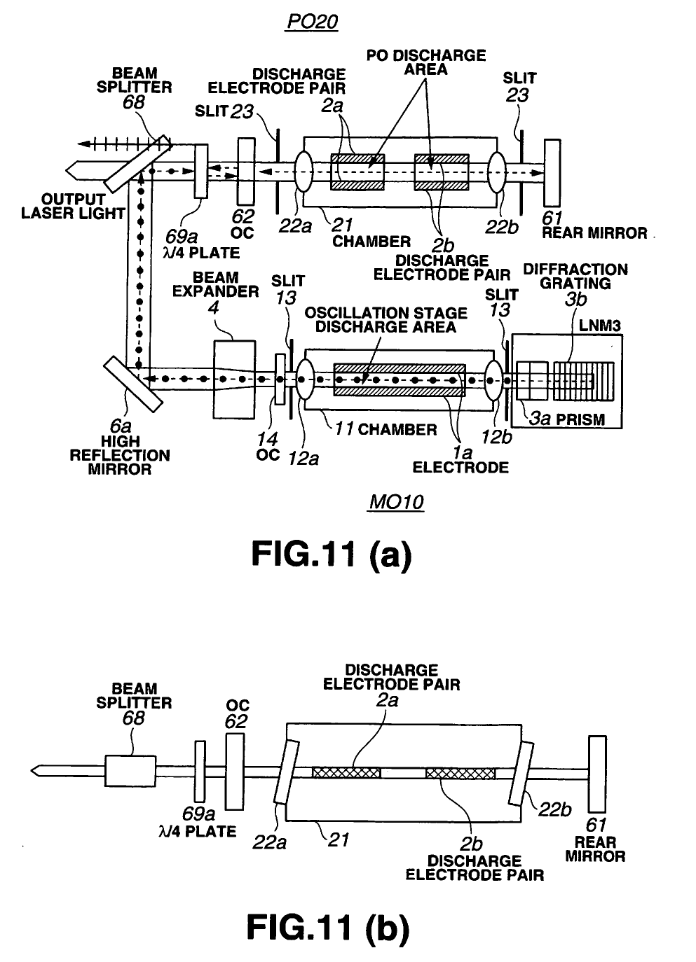

FIGS. 11(a) and 11(b) are diagrams showing the constitution of a laser device according to the eighth embodiment of the present invention, showing an example in which a Fabry-Perot type stable resonator is used as the resonator of the amplification stage laser (PO), and a polarized light element and wavelength plate are used for injecting the seed light. FIG. 11(a) shows a side view of the present embodiment, and FIG. 11(b) shows a top view of the amplification stage laser (PO) 20.

In FIG. 11(a), a prism beam expander 3a of the LNM3 of the oscillation stage laser (MO) 10 and windows 12a, 12b of the laser chamber 11 of the oscillation stage laser (MO) 10 are disposed at the Brewster angle, so the laser oscillates in a polarization plane perpendicular to the plane of the paper.

The beam of the laser light output from the oscillation stage laser (MO) 10 is expanded by the beam expander 4 while maintaining the polarization plane, is incident on and reflected by the high reflection mirror 6a, and enters a beam splitter (BS) 68 coated with a PS separation coating.

This BS 68 totally reflects s-polarized light (plane of polarization perpendicular to the plane of the paper). This reflected light is passed through a λ/4 plate 69, where it is converted into circularly polarized light. The seed light converted into circularly polarized light is injected from the OC 62 of the PO resonator into the optical resonator of the amplification stage laser (PO) 20 where it passes between the electrode gap of the discharge electrode pair 2a and 2b of the PO chamber 21, and passes through the window 22b. Then, the light is incident on and reflected by a rear mirror 61 that is coated with a high reflection coating, and again enters and passes through the PO chamber 21, is partially reflected by the OC 62, and again returned to the optical resonator of the amplification stage laser (PO) 20.

The laser light output as circularly polarized light from the OC 62 is again converted into the polarization plane that includes the plane of the paper by the λ/4 plate 69. Light in this polarization state is the p-polarized component of light of the BS 68, so virtually all passes through the BS 68 and is taken out as output laser light.

The discharge electrode pairs 2a and 2b of the amplification stage laser (PO) 20 are alternately discharged in synchronization with the seed light, as stated above. In this way, it is possible to obtain high pulse energy at high repetition rate (10 kHz or higher).

Here, in the present embodiment, the light is resonated within the PO resonator as circularly polarized light, so it is necessary that the AR coating of the windows 22a, 22b of the laser is a coating that is anti-reflective with respective to p- and s-polarized light.

The merits of the present embodiment are that the laser device operates with the reflectivity of the OC of the amplification stage laser (PO) between 20% and 30%, so it is possible to obtain a high injection efficiency of between 70% to 80%, and the alignment of the PO resonator is simple and stable. In the present embodiment a ¼λ plate is used, but preferably a zero order wavelength plate by combining two crystals of high purity MgF₂ is used as a wavelength plate that operates at 193 nm. The reason for this is to reduce the effect of heat generation, as the wavelength plate is disposed in a location where the laser output is high. Also, a reflection coating of dielectric material may also be made to function as a wavelength plate.

### (10) NINTH EMBODIMENT

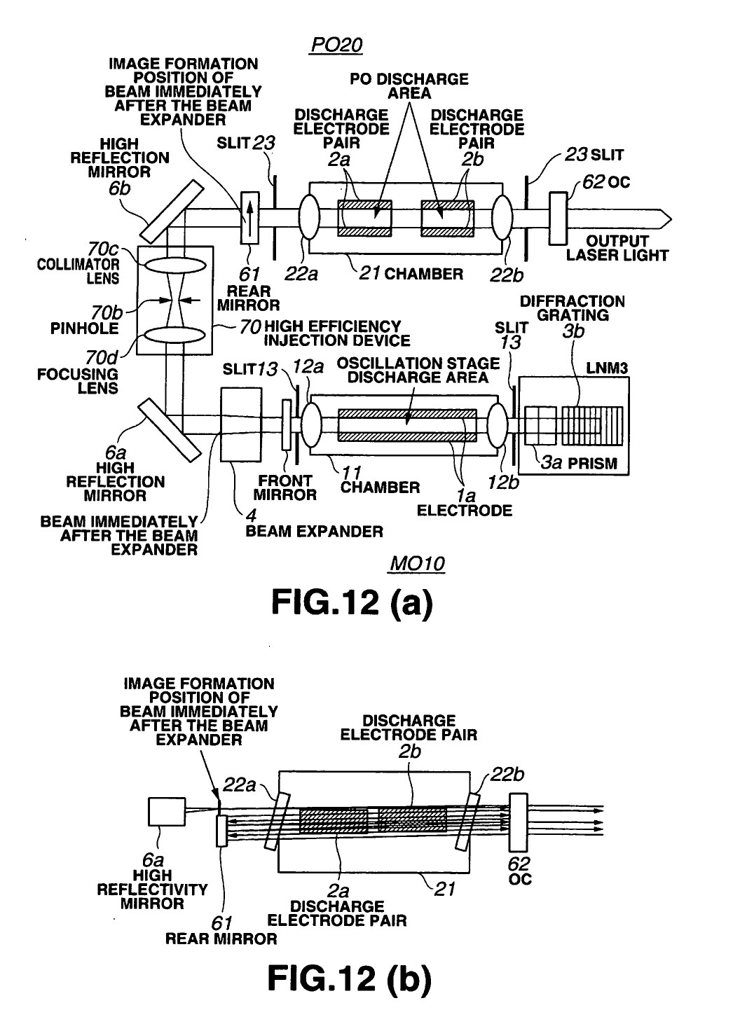

FIGS. 12(a) and 12(b) are diagrams showing the constitution of a laser device according to the ninth embodiment of the present invention, showing an example in which a Fabry-Perot type stable resonator is used as the resonator of the amplification stage laser (PO), and the injection efficiency of the seed light is improved by transferring the image of the seed light after beam expanding to the side position of the rear mirror of the PO resonator. FIG. 12(a) shows a side view of the present embodiment, and FIG. 12(b) shows a top view of the amplification stage laser (PO) 20.

In FIG. 12(a), the light output from the oscillation stage laser (MO) 10 is expanded in the discharge direction by the beam expander 4, and enters a high efficiency injection device 70 by the high reflection mirror 6a.

The high efficiency injection device 70 includes a focusing lens 70a, a pinhole 70b as a spatial filter, and a collimator lens 70c. The pinhole 70b is disposed at the position of the focal point f1 of the focusing lens 70a, and the positions of the pinhole 70b and collimator lens 70c are disposed at the focal length f2 of the collimator lens 70c.

The pinhole 70b is disposed at the position of the focal point of the focusing lens 70a, and the light of the oscillation stage laser (MO) 10 passes through the pinhole 70b. Then the light expands and is converted into parallel light by the collimator lens 70c. This parallel light is reflected by the high reflection mirror 6b, and as shown in FIG. 12(b), the beam forms an image at a position to the side of the rear mirror 61 immediately after the beam expander 4.

Forming the image as stated above can be achieved by arranging the distance from immediately after the beam expander to the focusing lens 70a to be f1, and arranging the distance from the collimator lens 70c to the side of the rear mirror 61 to be f2.

As shown in FIG. 12(b), the seed light that has formed an image to the side of the rear mirror is incident slightly inclined with respect to the light axis of the resonator of the amplification stage laser (PO) 20, and input into the PO chamber 21. Then the light passes through the window 22a, passes between the electrodes of the discharge electrode pairs 2a and 2b and is amplified, passes through the window 22b, the light that passes through the OC 62 which is coated with a partially reflection coating is output as the laser, part is reflected and is again returned to the PO chamber 21, where the light is amplified within the laser chamber 21, is incident on and reflected by the rear mirror 61 which is coated with a high reflection coating, and again enters the PO chamber 21. By repeating this process, the oscillations of the seed light is amplified.

The discharge electrode pairs 2a and 2b of the amplification stage laser (PO) 20 are alternately discharged in synchronization with the seed light, as stated above, so it is possible to achieve high repetition rates (10 kHz or greater) and high pulse energy output.

The merits of the device according to the present embodiment are as follows.

(i) The image of the beam at the exit of the beam expander 4 is transferred and formed at the injection position to the side of the rear mirror 61, so the beam does not broaden on the light path from the oscillation stage laser (MO) 10 to the amplification stage laser (PO) 20, so the injection efficiency of the seed light is increased.

(ii) There is a spatial filter in the high efficiency injection device 70, so it is possible to minimize the returned light from the PO resonator, so the laser oscillations of the oscillation stage laser (MO) 10 and the laser oscillations of the amplification stage laser (PO) 20 are stabilized.

In the present example, a spherical surface lens and a pinhole as spatial filter were adopted, however the present embodiment is not limited to this, and the configuration may include a cylindrical collective lens in the direction perpendicular to the plane of the paper, and a slit as the spatial filter. With this configuration the durability and so on of the spatial filter is improved.

### (11) MODIFICATION OF THE NINTH EMBODIMENT

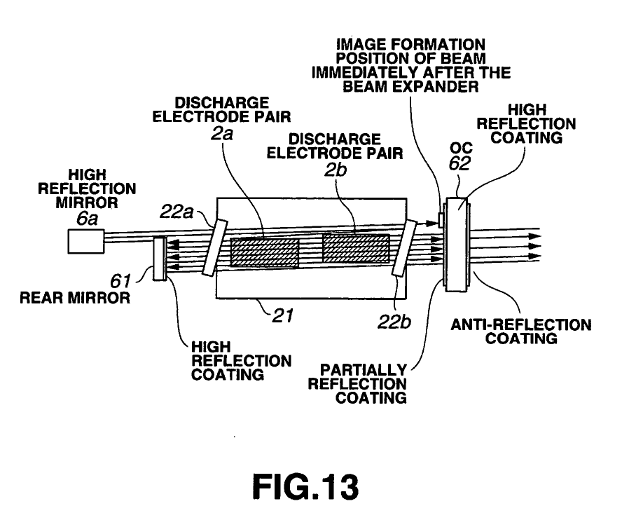

FIG. 13 is a diagram showing an example of the constitution of a laser device according to a modification of the ninth embodiment, showing an example in which a Fabry-Perot type stable resonator is used as the resonator of the amplification stage laser (PO), and the injection efficiency of the seed light is improved by transferring the image of the seed light after beam expansion to a high reflection coating area to the side of the OC of the PO resonator. This figure shows only the top surface of the amplification stage laser (PO) 20, but the remainder of the configuration is the same as that in FIGS. 12(a) and 12(b).

As shown in FIGS. 12(a) and 12(b), the light output from the oscillation stage laser (MO) 10 is expanded in the discharge direction by the beam expander, and enters the high efficiency injection device 70 via the high reflection mirror 6a. As stated previously, the high efficiency injection device 70 includes a focusing lens 70a, a pinhole 70b as a spatial filter, and a collimator lens 70c. The pinhole 70b is disposed at the position of the focal point f1 of the focusing lens 70a, and the positions of the pinhole 70b and collimator lens 70c are disposed at the focal length f2 of the collimator lens 70c.

The pinhole 70b is disposed at the position of the focal point of the focusing lens 70a, and the light of the oscillation stage laser (MO) 10 passes through the pinhole 70b. Then the light expands and is converted into parallel light by the collimator lens 70c. This parallel light is reflected by the high reflection mirror 6b, passes the side of the rear mirror 61, and from the window 22a of the PO chamber 21 passes through a space that is outside the space of the discharge electrode pairs space.

Then, after passing through the window 22a, the light enters the high reflection coating area of the OC 62 where it forms an image as shown in FIG. 13. The light that is reflected by this high reflection coating area passes between the electrodes of the discharge electrode pairs 2a, 2b, and is amplified. Then the light is again returned to the discharge space of PO chamber 21 by the rear mirror 61, which is coated with a high reflection coating, and amplified.

Then the light reflected by the partially reflection coating portion of the OC 62 is returned to the discharge space of the PO chamber 21 as feedback light. The laser light that has passed through the partially reflection coating of the OC 62 passes through an anti-reflection coating, and is output as output laser light.

The discharge electrode pairs 2a and 2b of the amplification stage laser (PO) 20 are alternately discharged in synchronization with the seed light, as stated above, so it is possible to achieve high repetition rates (10 kHz or greater) and high pulse energy output.

The merits of the device according to the present embodiment are as follows.

(i) The image of the beam at the exit of the beam expander is transferred and formed at the position of the high reflection coating area of the OC, so the beam does not broaden on the light path from the oscillation stage laser (MO) to the amplification stage laser (PO), so the injection efficiency of the seed light is increased. Furthermore, the injected light is amplified by the amount of one round circuit, so the injection efficiency is higher than the embodiment of FIGS. 12(a) and 12(b).

(ii) There is a spatial filter in the high efficiency injection device, so it is possible to minimize the returned light from the PO resonator, so the laser oscillations of the oscillation stage laser (MO) and the laser oscillations of the amplification stage laser (PO) are stabilized.

Also, in the present embodiment, the substrate of the OC is coated with a high reflection area, but the present embodiment is not limited to this, and it is possible to coat a knife edge type substrate with the high reflection coating, and dispose it between the OC and PO chambers, and inject the seed light into the discharge space of the amplification stage laser (PO) chamber.

### (12) TENTH EMBODIMENT

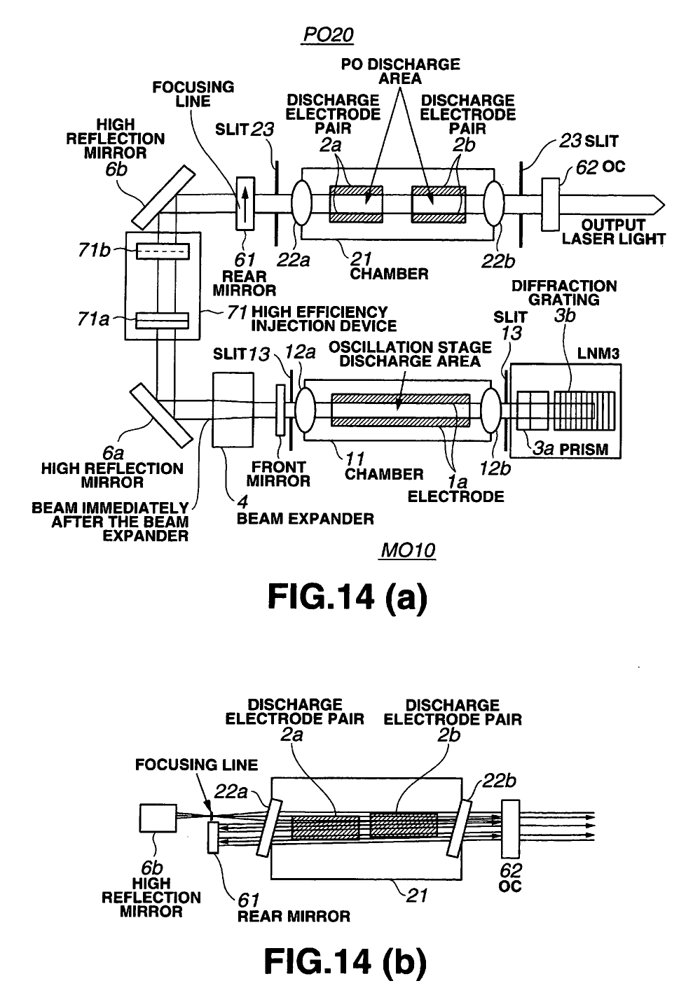

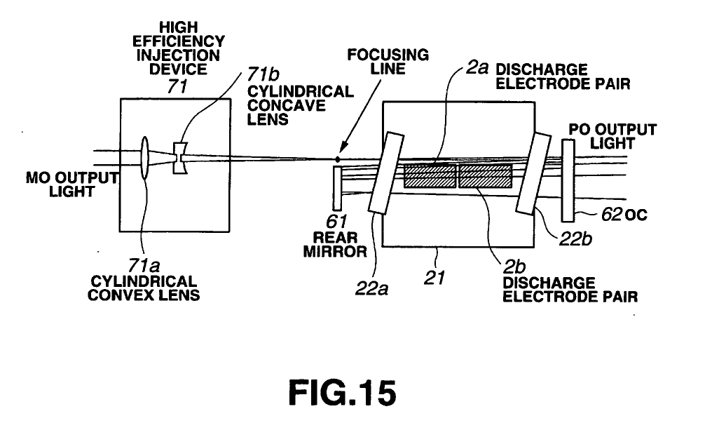

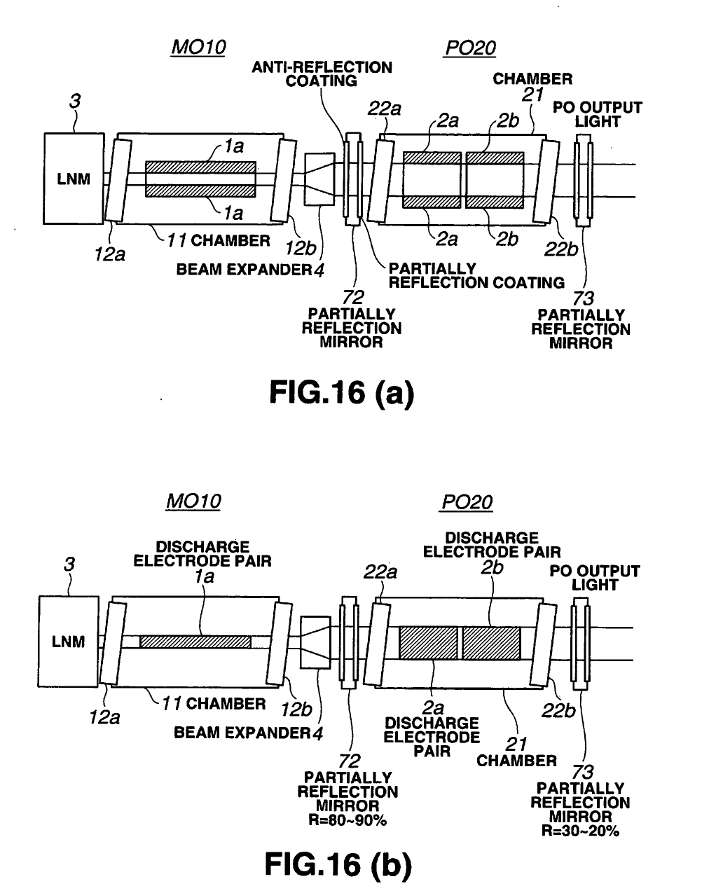

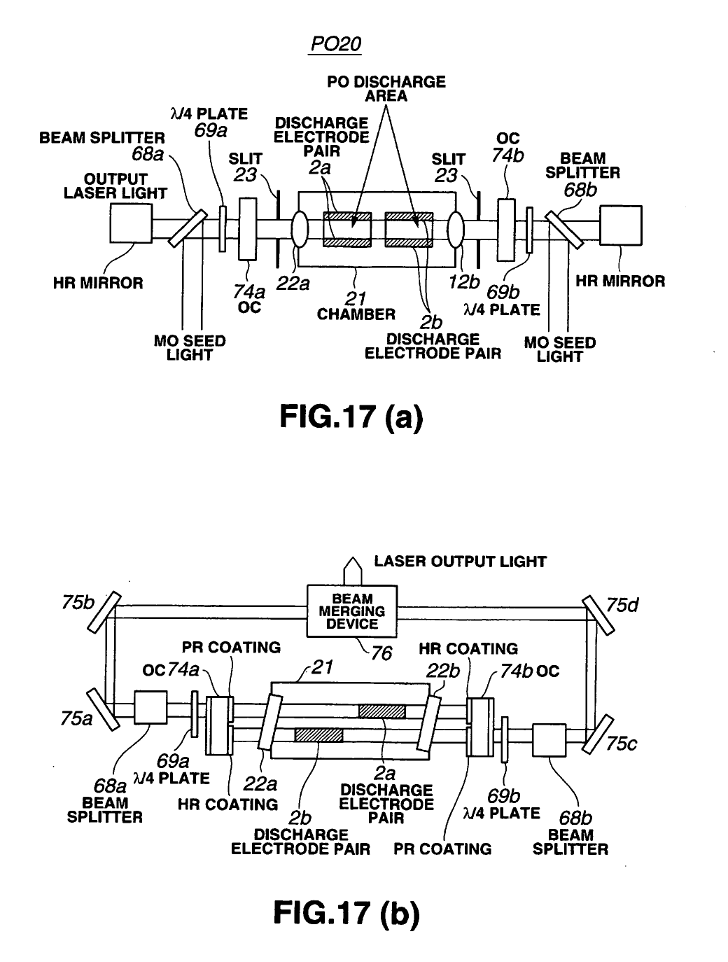

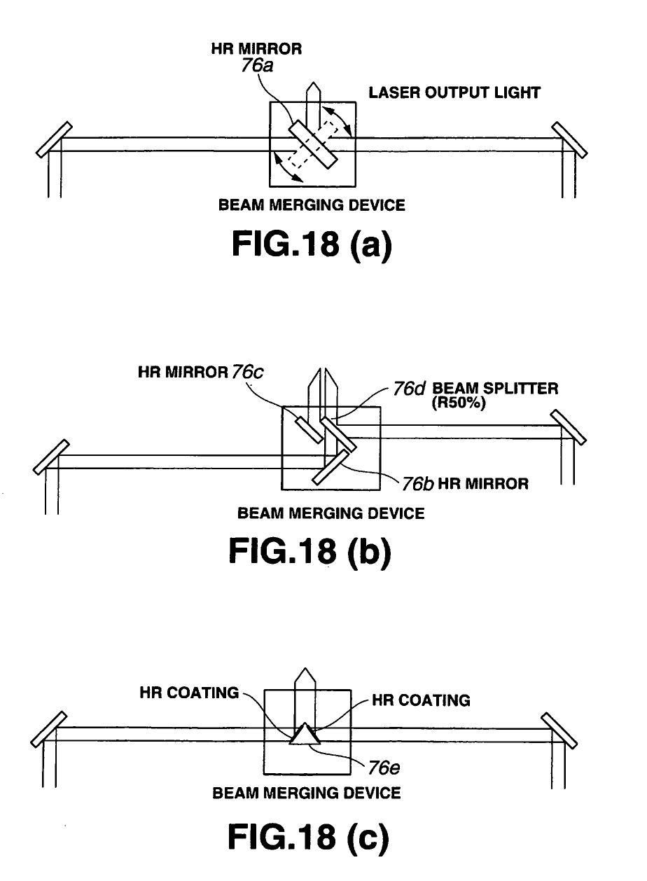

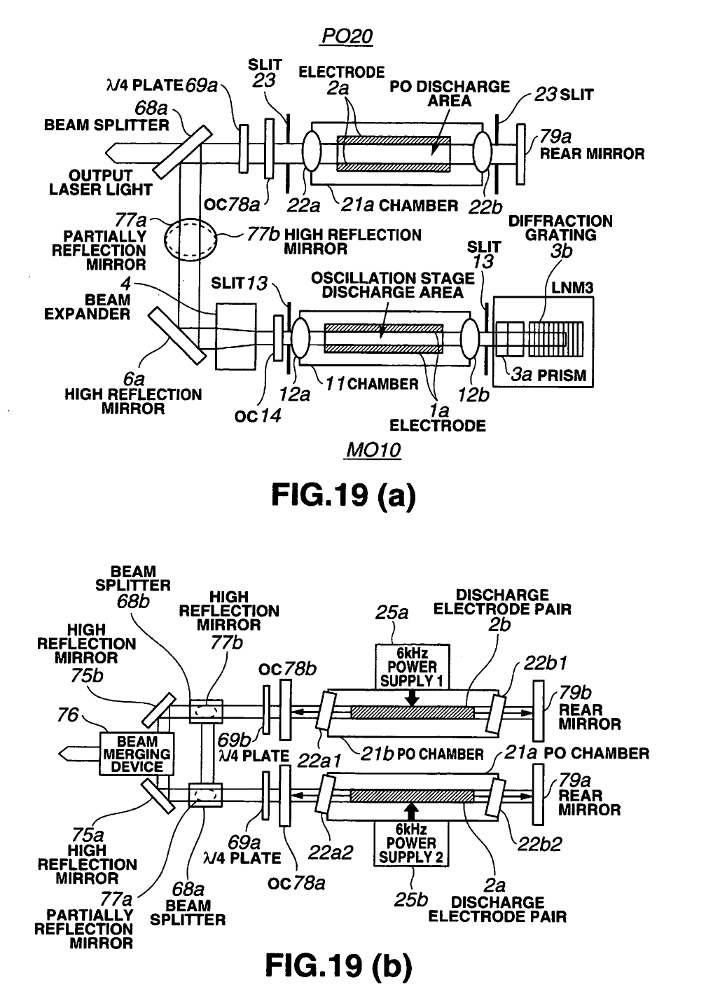

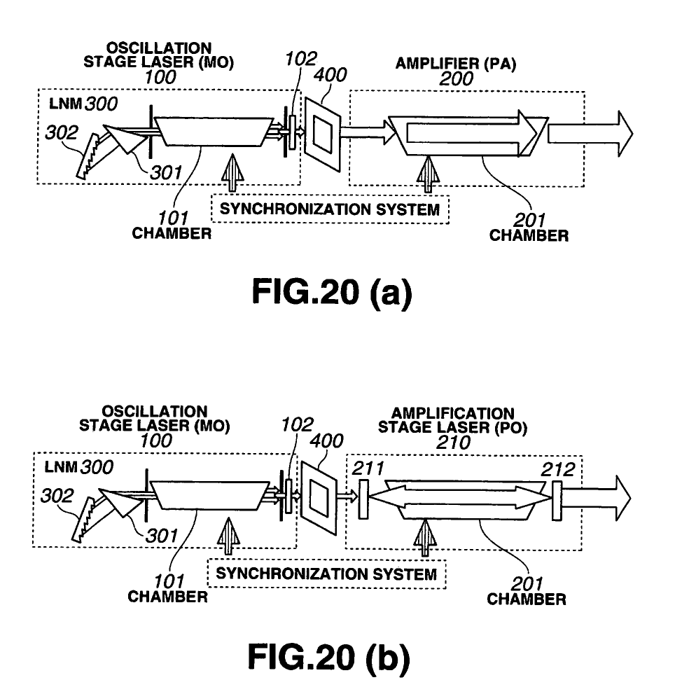

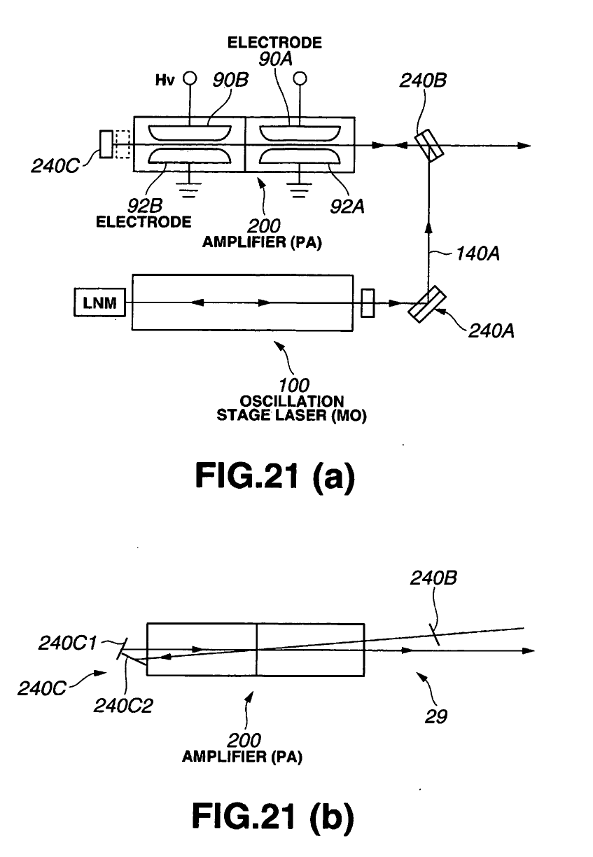

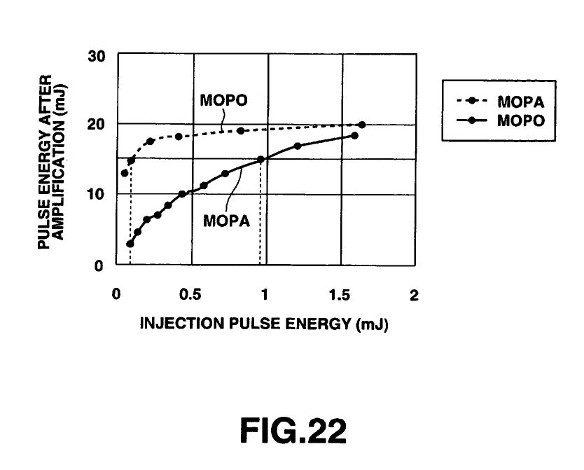

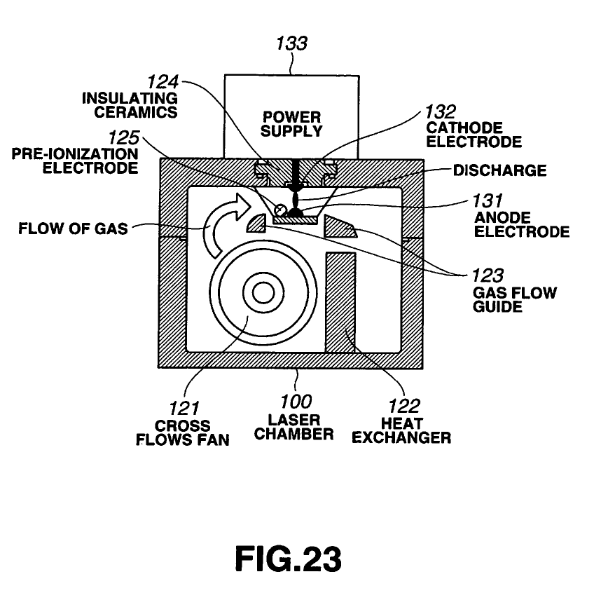

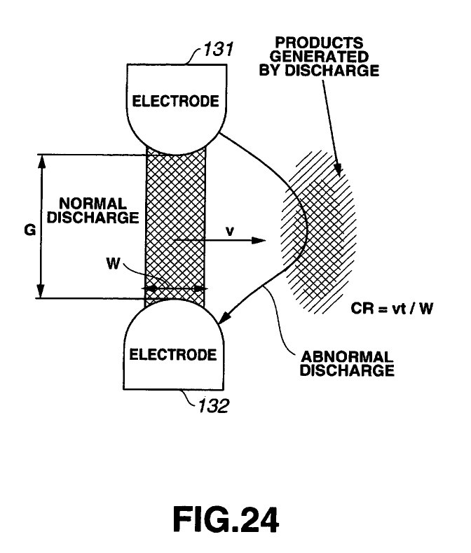

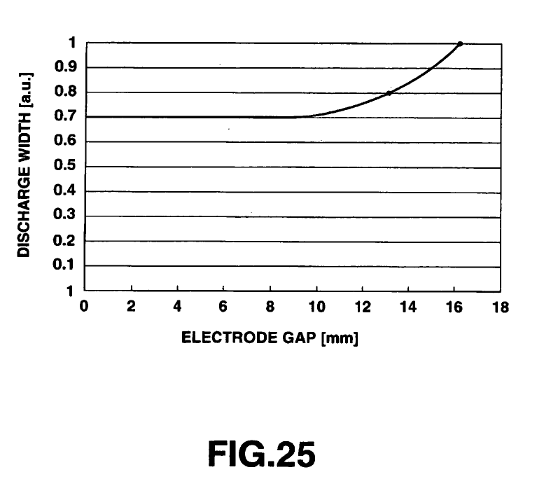

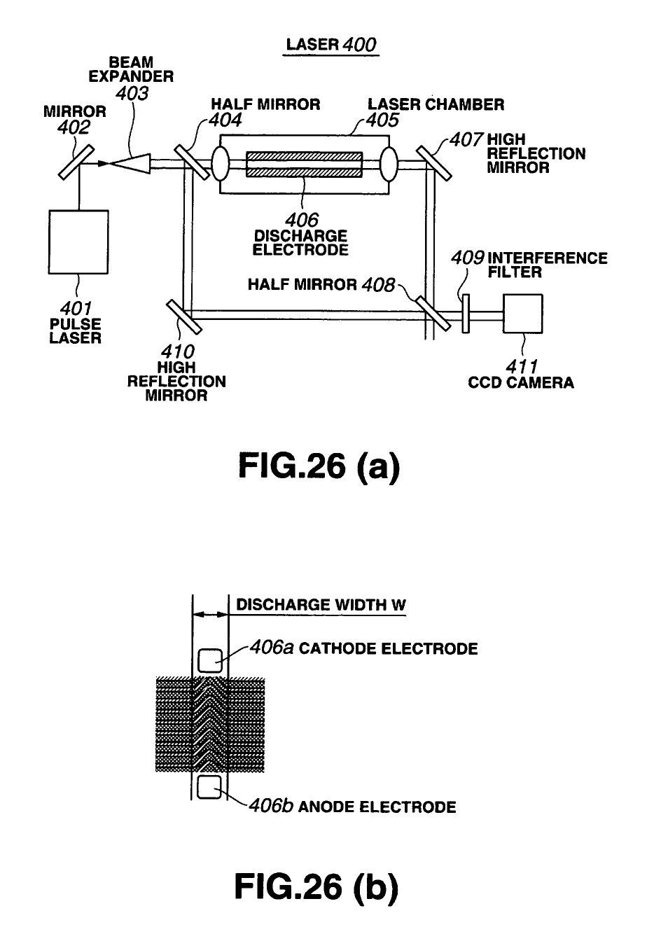

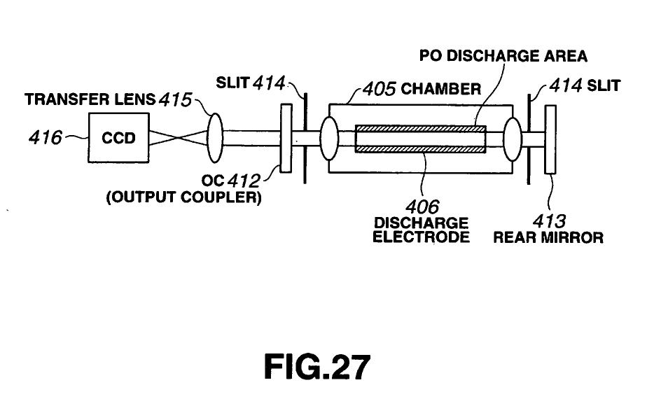

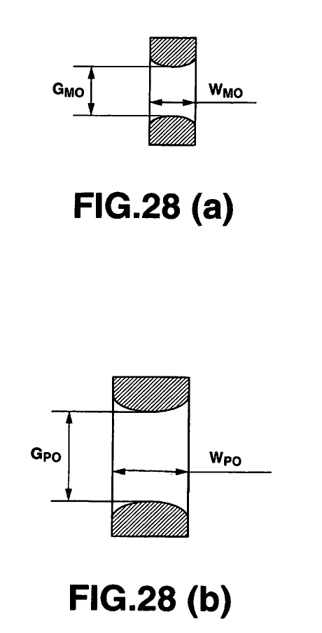

FIGS. 14(a) and 14(b) and FIG. 15 are diagrams showing the constitution of a laser device according to the tenth embodiment of the present invention, showing an example in which in the embodiment of FIGS. 12(a) and 12(b) the injection efficiency of the seed light is improved by focusing the seed light onto a line at a position to the side of the amplification stage laser (PO) resonator using a cylindrical lens, and injecting the light into the amplification stage laser (PO) optical resonator. FIG. 14(a) shows a side view of the present embodiment, FIG. 14(b) shows a top view of the amplification stage laser (PO) 20, and FIG. 15 shows the optical arrangement of the high efficiency injection device 71 and the amplification stage laser (PO) 20.

In FIGS. 14(a) and 14(b), the light output from the oscillation stage laser (MO) 10 is expanded in the discharge direction by the beam expander 4, and enters a high efficiency injection device 71 by the high reflection mirror 6a.

As shown in FIGS. 14(a), 14(b), and 15, the high efficiency injection device 71 includes a cylindrical convex lens 71a and a convex lens 71b. Using these two lenses, the seed light is reflected by the total reflection mirror 6b, and as shown in FIGS. 14(b) and 15, is focused onto a line at a position to the side of the rear mirror 61 of the resonator of the amplification stage laser (PO) 20.

As shown in FIGS. 14(b) and 15, the seed light broadens a little, is incident at a slight incline to the light axis of the resonator of the amplification stage laser (PO) 20 and is input to the PO chamber 21. After passing through the window 22a, the light is amplified by passing between the electrodes of the discharge electrode pairs 2a, 2b, passes through the window 22b, and the light that passes through the OC 62, which is coated with a partially reflection coating, is output as the laser, part of the light is reflected and is again returned to the PO chamber 21, is amplified in the laser chamber 21, is incident on and reflected by the rear mirror 61, which is coated with a high reflection coating, and again enters the PO chamber 21. By repeating this process, the oscillations of the seed light is amplified.

The discharge electrode pairs 2a and 2b of the amplification stage laser (PO) 20 are alternately discharged in synchronization with the seed light, as stated above, so it is possible to achieve high repetition rates (10 kHz or greater) and high pulse energy output.

The merits of the device according to the present embodiment are as follows.

(i) The seed light is focused onto a line at the injection position to the side of the rear mirror and then injected, so the injection efficiency of the seed light is increased.

(ii) Manufacturing a cylindrical lens with a long focal point is difficult, but in the present embodiment a combination of cylindrical concave and convex lenses is used for focusing, so it is possible to focus the light at a long focal point. Also, because the focal point is long (about from 1 m to 2 m), the angle of spread of the seed light after focusing is small, so the injection efficiency is improved.

The present embodiment is not limited to the embodiment as described above, and as shown in FIG. 13 an OC may be used, and the light may be focused onto a line on the high reflection coating of the OC, so the seed light is injected from the OC side.

### (13) ELEVENTH EMBODIMENT

FIGS. 16(a) and 16(b) are diagrams showing the constitution of a laser device according to the eleventh embodiment of the present invention, showing an example in which the OC of the oscillation stage laser (MO) and the rear mirror of the amplification stage laser (PO) are combined. FIG. 16(a) shows a side view of the present embodiment, and FIG. 16(b) shows a top view.

The oscillation stage laser (MO) 10 includes an LNM3 containing a wavelength selection element (grating) and a prism beam expander, as described previously, an MO chamber 11 containing discharge electrodes 1a with narrow electrodes and a narrow electrode gap, a beam expander 4 for expanding the beam so that the beam output from the oscillation stage laser (MO) 10 coincides with the discharge space of the amplification stage laser (PO) 20, and a partially reflection mirror 72. The partially reflection mirror 72 is coated with an anti-reflection coating on the MO chamber 11 side, and coated with a partially reflection coating on the PO chamber 21 side.

The oscillation stage laser (MO) 10 resonates between the LNM3 and the partially reflection surface of the partially reflection mirror 72, and seed light with a narrow spectrum is output.

On the other hand, the amplification stage laser (PO) 20 includes the PO chamber 21 which contains the partially reflection mirror 72 and the discharge electrode pairs 2a and 2b, and a partially reflection mirror 73. The optical resonator of the amplification stage laser (PO) 20 includes the partially reflection surface of the partially reflection mirror 72 and the partially reflection surface of the partially reflection mirror 73 (reflectivity R=30 to 20%).

Therefore, all the seed light output from the oscillation stage laser (MO) 10 is injected into the PO resonator of the amplification stage laser (PO) 20.

Here, it is possible to make the reflectivity R of the partially reflection mirror 72 from 80% to 90%, so even if the oscillation stage laser (MO) 10 has low gain, stable low output (0.1 mJ) laser light can be output. Also, the injection efficiency of the PO resonator is 100%, so it is possible to amplify the oscillations even for a small MO output (0.1 mJ).

### (14) TWELFTH EMBODIMENT

FIGS. 17(a) and 17(b) are diagrams showing the constitution of a laser device according to the twelfth embodiment of the present invention. The present embodiment is a modification of the embodiment of FIGS. 11(a) and 11(b), and is an embodiment in which the discharge electrode pairs of the PO chamber are disposed mutually differently from each other, a separate optical resonator is disposed corresponding to each discharge electrode pair, and light polarizing elements and a wavelength plate are used to inject the seed light, the same as in FIGS. 11(a) and 11(b). FIG. 17(a) shows a side view of the amplification stage laser (PO) of the present embodiment, and FIG. 17(b) shows a top view of the amplification stage laser (PO).

In FIGS. 17(a) and 17(b), the seed light of the oscillation stage laser (MO) is expanded by the beam expander, as was explained for FIGS. 11(a) and 11(b), is split into two by a wave separator that is not shown in the drawings, and enters beam splitters (BS) 68a, 68b coated with PS separation coating provided at both sides of the chamber 21 of the amplification stage laser (PO) 20.

As explained for FIGS. 11(a) and 11(b), the BS 68a, 68b totally reflects s-polarized light (polarization plane perpendicular to the plane of the paper), the reflected light passes through λ/4 plates 69a, 69b, and is injected into the chamber 21 of the amplification stage laser (PO) 20 via OC 74a, 74b provided at both ends of the chamber 21.

The OC 74a, 74b are in part coated with a partially reflection (PR) coating, and in the other part coated with a high reflection (HR) coating, seed light injected from the BS 68a side is injected into the chamber 21 via the PR coated part of the OC 74a, and seed light injected from the BS 68b side is injected into the chamber 21 via the PR coated part of the OC 74b.

The seed light injected from the BS 68a side passes through the electrode gap of the discharge electrode pair 2a of the PO chamber 21, is reflected by the HR coated part of the OC 74b, and returned to the PO chamber 21. Then, the seed light passes through the electrode gap of the discharge electrode pair 2a, is partially reflected by the OC 74a, and the remainder is output from the OC 74a. The output light is converted into light with a p-polarized component by the λ/4 plate 69a, virtually all passes through the BS 68a and is taken off as output laser light, and enters a beam merging device 76 via high reflection mirrors 75a, 75b.

In the same way, the seed light injected from the BS 68b side passes through the electrode gap of the discharge electrode pair 2b of the PO chamber 21, is reflected by the HR coated part of the OC 74a, and returned to the PO chamber 21. Then, the seed light passes through the electrode gap of the discharge electrode pair 2b, is partially reflected by the OC 74b, and the remainder is output from the OC 74b. The output light is converted into light with a p-polarized component by the λ/4 plate 69b, virtually all passes through the BS 68b and is taken off as output laser light, and enters the beam merging device 76 via high reflection mirrors 75c, 75d.

These light beams are merged in the beam merging device 76, and taken off as output laser light.

FIGS. 18(a) through 18(c) show an example of the constitution of the beam merging device 76.

FIG. 18(a) shows a rotating mirror system, in which a high reflection mirror (HR mirror) 76a is rotated in synchronization with the discharge of the discharge electrodes 2a, 2b, and the two outputs are merged.

FIG. 18(b) shows a system for merging beams using a beam splitter (BS), using the high reflection mirrors 76b, 76c and the BS 76d with a reflectivity of 50%, one of the two output light beams is made incident on the BS 76d, the other of the two light beams is reflected by the high reflection mirror 76b and made incident on the BS 76d, and by reflecting the transmitted light and the reflected light of the BS 76d by the high reflection mirror 76c, the two output light beams are merged.

FIG. 18(c) shows a beam merging system using a prism, using a prism 76e that is coated with high reflection (HR) coating on both input surfaces, the two output light beams are merged.

The merit of the embodiment shown in FIGS. 17(a) and 17(b) is because the discharge electrode pairs are differently disposed with respect to each other, and a separate optical resonator is disposed corresponding to each discharge electrode pair, the variation in the laser beam output from each PO resonator is small.

Also, the present embodiment is not limited to this embodiment, and the light output from the oscillation stage laser (MO) may be expanded by the beam expander, the beam may be split by a beam splitter, and injected in parallel into the respective PO optical resonators for the two POs. Then the oscillations in the respective POs are alternately amplified and in synchronization with the split light, merged by the beam merging device, and output.

### (15) THIRTEENTH EMBODIMENT

FIGS. 19(a) and 19(b) are diagrams showing the constitution of a laser device according to the thirteenth embodiment of the present invention. The present embodiment is a modification of the embodiment of FIGS. 17(a) and 17(b), and is an embodiment in which two PO chambers are provided, each PO chamber is provided with its own optical resonator, and light polarizing elements and a wavelength plate are used to inject the seed light, the same as in FIGS. 11(a) and 11(b). FIG. 19(a) shows a side view of the present embodiment, and FIG. 19(b) shows a top view of the amplification stage laser (PO).

In FIGS. 19(a) and 19(b), the seed light from the oscillation stage laser (MO) 10 is expanded by the beam expander 4, totally reflected by the high reflection mirror 6a, and enters a 50% reflecting partially reflection mirror 77a. The seed light is split into two as transmitted light and reflected light by the partially reflection mirror 77a, and as shown in FIG. 19(b), one light beam passes through the partially reflection mirror 77a, and enters a beam splitter (BS) 68a, which is coated with a PS separation coating, of one of the PO resonators. The other light beam is reflected by the partially reflection mirror 77a and enters, via a high reflection mirror 77b, a beam splitter (BS) 68b, which is coated with a PS separation coating, of one of the PO resonators.

As explained for FIGS. 11(a) and 11(b), the BS 68a, 68b totally reflect s-polarized light (polarization plane perpendicular to the plane of the paper in FIG. 19(a)), the reflected light passes through λ/4 plates 69a, 69b, and is injected into the chambers 21a, 21b of the amplification stage laser (PO) 20 via OC 78a, 78b.

The seed light injected from the BS 68a side passes through the electrode gap of the discharge electrode pair 2a of the PO chamber 21a, is reflected by a rear mirror 79a, and returned to the PO chamber 21a. Then, the seed light passes through the electrode gap of the discharge electrode pair 2a, is partially reflected by the OC 78a, and the remainder is output from the OC 78a. The output light is converted into light with a p-polarized component by the λ/4 plate 69a, virtually all passes through the BS 68a and is taken off as output laser light, and enters a beam merging device 76 via a high reflection mirror 75a.

The seed light injected from the BS 68b side passes through the electrode gap of the discharge electrode pair 2b of the PO chamber 21b, is reflected by a rear mirror 79b, and returned to the PO chamber 21b. Then, the seed light passes through the electrode gap of the discharge electrode pair 2b, is partially reflected by the OC 78b, and the remainder is output from the OC 78b. The output light is converted into light with a p-polarized component by the λ/4 plate 69b, virtually all passes through the BS 68b and is taken off as output laser light, and enters the beam merging device 76 via the high reflection mirror 75b.

These light beams are merged in the beam merging device 76, and taken off as output laser light. As an example of beam merging device, the device shown in FIGS. 18(a) to 18(c) may be used.

In the present embodiment, two PO chambers are provided, and each PO chamber is provided with its own optical resonator, but the present embodiment is not limited to this example, and resonators as shown in FIGS. 12(a), 12(b), 13, 14(a), and 14(b) may be disposed, the seed light may be split into two beams, and injected into the respective resonators.

What is claimed is:

1. A laser device for an exposure device which is an injection locked laser device for an exposure device, comprising a line narrowed oscillation stage laser and an amplification stage laser having at least a pair of optical stable resonators, further comprising:
an injection device that injects oscillating stage laser light into the optical stable resonator, wherein
a plurality of pairs of discharge electrodes are disposed within the optical resonator of the amplification stage laser device, and each electrode pair is connected to a power supply circuit for discharging the electrode pair, and
at least one pair of the electrode pairs is discharged in synchronization with the injected light.

2. A laser device for an exposure device which is an injection locked laser device for an exposure device, comprising a line narrowed oscillation stage laser and at least a plurality of amplification stage lasers having an optical stable resonator, further comprising:
an injection device that splits oscillation stage laser light and injects the laser light into the optical stable resonator of each of the amplification stage lasers, wherein
at least one of the plurality of amplification stage lasers is discharged in synchronization with the injected light.

3. The laser device for an exposure device according to claim 1, further comprising a beam expander that is disposed on a light path between the oscillation stage laser and the amplification stage laser, and that expands a beam output from the oscillation stage laser in at least a direction of an electrode gap.

4. The laser device for an exposure device according to claim 2, further comprising a beam expander that is disposed on a light path between the oscillation stage laser and the amplification stage laser, and that expands a beam output from the oscillation stage laser in at least a direction of an electrode gap.
